(19) United States
(12) Patent Application Publication
(10) Pub. No.: US 2002/0005812 A1
(43) Pub. Date: Jan. 17, 2002

(54) Pipe testing apparatus and method

(76) Inventors: John T. Kuo, Blauvelt, NY (US); Gale D. Burnett, Lynden, WA (US)

Correspondence Address: ROBERT B. HUGHES, HUGHES & SCHACHT, P.S., 2801 MERIDIAN STREET, SUITE 1, BELLINGHAM, WA, 98225-2412, US

(21) Appl. No.: 09/760,228

(22) Filed: Jan. 12, 2001

Related U.S. Application Data
(63) Continuation of application No. 09/173,506, filed on Oct. 15, 1998, now abandoned.
Application No. 09/173,506 is a continuation-in-part of application No. 09/085,547, filed on May 27, 1998, now abandoned.
Application No. 09/085,547 is a continuation-in-part of application No. 08/807,645, filed on Feb. 27, 1997, now Pat. No. 6,194,902.
(60) Provisional application No. 60/047,925, filed on May 29, 1997.
(60) Provisional application No. 60/012,336, filed on Feb. 27, 1996.

(51) Int. Cl. H01Q 19/12; H01Q 1/52

(52) U.S. Cl. 343/840; 343/841

(57) ABSTRACT

An antenna assembly for transmitting electromagnetic signals to and receiving electromagnetic signals from a conductive member. The antenna assembly comprises a reflector member, a focus rod, a focus element, and an insulating member. The reflector member defines a reflecting surface having a substantially parabolic cross-section. The focus element has a first surface and is mounted on the focus rod. The insulating member mounts the focus rod on the reflector member such that the focus element is arranged substantially at the focal point of the reflecting surface with the first surface facing the reflecting surface. When the reflector member is arranged with the reflecting surface facing the conductive member, the antenna assembly operates in a transmit mode or a receive mode. In the transmit mode, electromagnetic signals travel along the focus rod, radiate from the focus element, and reflect off of the reflecting surface and are transmitted to the conductive member. In the receive mode, electromagnetic signals travelling along the conductive member radiate from the conductive member, reflect off of the reflecting surface, excite the focus element, and travel through the focus rod.

### RELATED APPLICATIONS

This is a continuation of Continued Prosecution Application (CPA) filed Aug. 23, 2000, continued from U.S. patent application Ser. No. 09/173,506 filed Oct. 15, 1998, which is a continuation-in-part of U.S. Ser. No. 09/085,547 filed May 27, 1998, which both is a continuation-in-part of U.S. patent application Ser. No. 08/807,645 filed on Dec. 27, 1997, and claims the benefit of U.S. Provisional Application Ser. No. 60/047,925 filed on May 27, 1997. The benefit of the filing of U.S. Provisional Application Ser. No. 60/012,336 filed Feb. 27, 1996, is further claimed via said U.S. patent application Ser. No. 08/807,645 which claims the benefit thereof.

### BACKGROUND OF THE INVENTION

1. Field of the Invention

The present invention relates to a system, apparatus and method for testing elongate objects, such as pipe, pipeline, as well as storage tank, etc., and is directed toward the problem of detecting corrosion, and/or defects, and/or other anomalies to the pipe or pipeline under conditions where access and/or visual or instrumental inspection of the pipe or pipeline is either limited, not possible, or impractical.

2. Background Art

In petroleum processing and petrochemical plants and other industrial environments, it is common to have numerous pipes extending between various locations in the plant, with these pipes carrying fluid or gas (e.g., petroleum products), often under intensive heat and high pressure. Likewise, trans-continental and interstate oil/gas pipelines under even higher pressure extend hundreds and thousands miles.

Similarly, pipelines carry toxic and nontoxic wastes, and storage tanks store high pressure gas and other volatile petroleum products, etc. These pipes or pipelines are invariably made of steel and can have an inside diameter ranging anywhere from two to sixty inches, or even outside of this range. The exterior of these pipes or pipelines are often insulated, and shielded with the insulating and metallic shielding layers being as great as approximately ⅛ to 5 inches or more in thickness, or outside of this range. Moreover, these pipes or pipelines are interconnected by joints, elbow joints, flanges, etc., while their geometrical configurations of the layouts are complex.

For a number of reasons, (safety, environmental potential hazards, avoiding costly shut-downs, etc.), the integrity of these pipes or pipelines must be preserved. Corrosion and/or defects in the pipe or pipeline can occur for a number of reasons. One is that moisture condensates can collect between the insulating layers and the pipe or pipeline, thus causing corrosion (i.e., rust). Visual inspection of the steel pipe that is encapsulated in insulation is not possible unless the layers of insulation and shielding are removed, and then replaced. This is expensive and time consuming, and as a practical matter it would be economically unfeasible to accomplish the inspections with reasonable frequency.

U.S. Pat. No. 4,970,467, Burnett, issued on Nov. 13, 1990. The method and apparatus in this patent are directed toward detection of corrosion in pipes and pipelines. Two pulses are transmitted into the pipe to travel toward one another, and these pulses intersect at an intermediate location. If there is corrosion at the location of the intersection, then this affects the pulses in a way which would be indicative of corrosion, and the resulting wave forms would differ from those which would result where the intersection of the pulses is at an uncorroded area of the pipe. By timing the transmission of the two pulses and shifting the transmitting times in increments, the point of intersection can be stepped along the pipe or pipeline so that corrosion can be detected at various locations.

Also, there is a group of patents relating to detection of corrosion in pipelines, these being the following: U.S. Pat. No. 4,839,593, No. 4,990,851, No. 4,929,898, and No. 4,926,896. Three of these issued to Brian R. Spies as inventor, and one to Pedro F. Lara as inventor. These patents deal with a transient electromagnetic method of detecting irregularities on container walls of pipelines by measuring wall thickness. Basically the inventors utilize transient electromagnetic probing called “TEMP”, which allows the remote probing of a conductor by inducing a current into the conductor and analyzing the decay of current. It is the induced field with which these patents deal.

There is a fundamental difference between those four patents and the present invention. The method in those four patents is based completely on the quasi-static electromagnetic phenomenon, which is a different field and neglects the propagation field entirely with which the present patent application deals. It is stated that it is only the conductivity of the container which plays a role in the diffusion of induced field in the conductor, and they are measuring the decay of the induced diffusion field in the conductor.

The present invention fundamentally is completely different from the above mentioned four patents. The present invention deals for the first time with the complete dynamic electromagnetic phenomenon, which is about the dynamic aspects of electromagnetic wave propagation, reflection and refraction, diffraction, attenuation, dispersion, etc. It is the propagating field with which the present invention deals. The conductivity of the conductor is just one of the electromagnetic parameters, which gives only the attenuation of an electric pulse. More importantly, the present invention deals with the permittivity which in essence controls the dynamic electromagnetic wave propagation. In the dynamic electromagnetic wave phenomenon, the conductivity enters into the attenuation of electromagnetic wave propagation, and the permittivity fundamentally governs the propagation field. Naturally, the present invention also deals with permeability, and the permeability plays a role in both attenuation and propagation.

Other patents of possible interest will be cited in a prior art statement to be filed subsequently to the filing of the present application.

It is the object of the present invention to provide a means of inspecting pipes or pipelines under the in situ environments and circumstances that corrosion, and/or defects, and/or other anomalies can be detected with a relatively high degree of reliability, and that the various difficulties of inspection, such as those mentioned above, can be eliminated and/or alleviated.

### SUMMARY OF THE INVENTION

The present invention comprises both a method and a system for identifying corrosion on an electromagnetically permeable elongate member, such as a pipe. It is the object of the present invention to provide such a system which is particularly adapted for ascertaining the presence and location of such corrosion under conditions where access and/or visual or instrumental inspection of the pipe is either limited, not possible or impractical. The particular application of the present invention is to detect corrosion on pipes or pipelines, and the present invention has been found to be particularly effective where the pipe or pipeline is either covered by insulation, buried underground, or being inaccessible when extending underneath a roadway.

The method of the present invention comprises transmitting electric or electromagnetic pulses (waves) into the elongate member in the transmitting location of the elongate member and at a transmitting time to cause the pulse to travel as the propagating electromagnetic wave to a receiving location over a travel distance and during a travel time interval. The electromagnetic wave is then received at a receiving time at the receiving location on the elongate member. Then any delay in said electromagnetic wave traveling over the travel distance is ascertained to determine the presence of corrosion on the elongate member.

The pulse has a sufficiently high frequency so that the electromagnetic wave travels over the near surface of the elongate member at a very thin skin depth for corrosion on an exterior surface on the elongate member may be present. The receiving means is operatively positioned at the receiving location to receive the electromagnetic wave. The receiving means in one preferred form comprises an antenna, or the like, responsive to electromagnetic radiation, resulted from refraction, reflection and diffraction of electromagnetic waves.

In one embodiment, the receiving means comprises a plurality of receivers which are operatively positioned at spaced receiving locations along the lengthwise axis of the elongate member. In this arrangement, the method further comprises:

a. ascertaining distances between said spaced receiving location;

b. ascertaining times of travel of said electromagnetic waves between said receiving locations;

c. ascertaining from said distances and said times of travel, velocity of said electromagnetic waves between said receiving locations to identify presence of corrosion; and

d. analyzing the waveform for characteristics of the electromagnetic waves indicative of dispersion, attenuation, and phase shift that may be attributed to corrosion.

The method further comprises ascertaining an area or areas between two receiving locations where the velocity of the electromagnetic wave or waves is lower, to identify presence and location of corrosion.

In several preferred embodiments, it is provided a multi-channel cable, comprising a plurality of channels, and each of said receivers is operatively connected to a respective one of the channels. The multi-channel cable directs signals received from the receiver to a data receiving location. In one arrangement, the multi-channel cable is a fiber-optic cable, and in another arrangement an electrically conductive multi-channel cable.

The pulse is transmitted to the elongate member by directing a pulse from a pulse generator through the cable to a transmitter at the transmitting location, with the transmitter in turn transmitting an electric or electromagnetic pulse into the elongate member at the transmitting location. The multi-channel cable transmits the received signal to a data acquisition signal analyzer means. Also, the pulse generator transmits a triggering signal to a data acquisition signal analyzer.

To accomplish both forward profiling and reverse profiling of the elongate member, the pulse is transmitted into a first end of the section of the elongate member which is under test, and this pulse is received at a second end location of the section of the elongate member. Then a second pulse or a set of pulses is transmitted from the second end of the section of the elongate member under test toward the first end of the section of the elongate member, where the signal is received and delivered to a data receiving location.

In another embodiment, the transmitter is positioned at the transmitting location to transmit the pulse into the elongate member. The receiver is positioned sequentially at a plurality of spaced receiving locations along the elongate member. The pulses are transmitted into the elongate member for each receiving location at which the receiver is placed, and signals received by the receiver at the receiving locations are transmitted to a data receiving location.

As indicated above, the present invention is particularly adapted for detecting a corrosion of a pipe having an insulating layer. In this instance, the method further comprises providing a receiver which is an antenna or the like responsive to electromagnetic radiation. The receiver is placed adjacent to an outer surface of the insulating and shielding layers of the pipe to receive the electromagnetic wave. Also, a portion of the insulation is removed at the transmitting location, and the transmitter is placed adjacent to the pipe at the transmitting location:

In one arrangement, the transmitter comprises an electrical contact member which is placed into direct contact with the pipe, and an electric current is transmitted to the transmitter. In another arrangement, the transmitter is a directional antenna, which is positioned adjacent to the pipe. An electric pulse is transmitted to the antenna which in turn transmits an electromagnetic pulse into the pipe. In one arrangement, the receiving means comprises a plurality of antennas which are placed adjacent to the insulation of the pipe at a plurality of the receiving locations.

In another embodiment, there is a plurality of transmitters which are spaced circumferentially from one another at the transmitting location. A plurality of electric or electromagnetic pulses are transmitted from these transmitters into the elongate member, either sequentially, simultaneously, or both simultaneously and sequentially toward a receiving location or locations.

Also, in another arrangement there is a plurality of receivers at the receiving location which are spaced circumferentially from one another. Pulses or electromagnetic waves are transmitted from selected transmitters to the receivers at the receiving location in selected patterns.

In the system of the present invention, the transmitting means comprises one or a plurality of transmitters, as described previously in this text, and one receiver or a plurality of receivers. Also, there is provided a means to ascertain a time interval of travel of the electromagnetic wave from the transmitting location to the receiving location.

Also, the system comprises means to ascertain intervals of travel time between various pairs of two receivers to identify where the velocity of the electromagnetic wave or waves is lower.

As described above, several embodiments of this system comprise multi-channel cables.

Other components and functions of the system of the present invention are disclosed in the previous text in the “Summary of the Invention”, and also it will be apparent from the following detailed description.

### BRIEF DESCRIPTION OF THE DRAWINGS

FIGS. 1A and 1B are schematic drawings of a first embodiment of the present invention, with

FIG. 1A showing the system in a forward profiling mode, and

FIG. 1B showing the system in the reverse profiling mode;

FIGS. 1C and 1D are schematic drawings corresponding to FIGS. 1A and 1B but showing a second embodiment;

FIGS. 2A and 2B are schematic drawings similar to FIGS. 1A and 1B, but showing a third embodiment of the present invention (and also showing the basic system for a fourth embodiment which is described verbally).

FIGS. 3A and 3B are two schematic drawings illustrating a fifth embodiment of the present invention;

FIG. 4 is a schematic arrangement with marching pairs of transmitters and receivers for measuring interval differences;

FIGS. 5A and 5B are two isometric views showing schematically helical paths as expressed by mathematical formulas relating thereto.

FIG. 6A is an isometric view of a pipe showing the path of the first arrival of an electromagnetic wave;

FIG. 6B is an isometric view and also an equivalent laid out two-dimensional view of an electromagnetic propagation wave of the second arrival along the pipe;

FIG. 6C is both an isometric view and plan view similar to 6B, but showing the third arrival;

FIG. 6D is an isometric view and a two dimensional view similar to FIGS. 6B and 6C showing the paths of two fourth arrivals of the electromagnetic wave;

FIG. 7A is a sectional view of a transmitting and/or receiving antenna used in the present invention;

FIG. 7B is a top plan view thereof;

FIGS. 8A and 8B are section views of a cylindrical pipe or pipeline indicating the locations of transmitting and/or receiving antenna;

FIGS. 9A, 9B, 9C are side bottom and top views of a transmitter that is magnetically attached to the pipe;

FIG. 10 is a graph plotting time (T) versus distance (x) along pipe test section;

FIG. 11 is schematic drawings illustrating yet another embodiment of the present invention;

FIGS. 12-14 are signal analyzer traces showing that a portion of a signal obtained using an antenna outside the insulation are virtually identical to a similar portion of a signal obtained with the insulation removed;

FIGS. 15-17 are signal analyzer traces showing EM-gram signals obtained for a variety of cases of pipe under insulation and shield.

### DESCRIPTION OF THE PREFERRED EMBODIMENTS

1. Anomaly Detection

It is expedient that we first introduce the present invention through the basic techniques of detection of corrosion, and/or defects of a pipe or pipeline under test, the operations, the underlying phenomena, the relevant devices developed, and the methods of analysis and interpretation with all the relevant supporting documents and for the use of a variety of hardware including multi-channel cable and single-channel cable, source and receiving antennas that would set the stage of what follows.

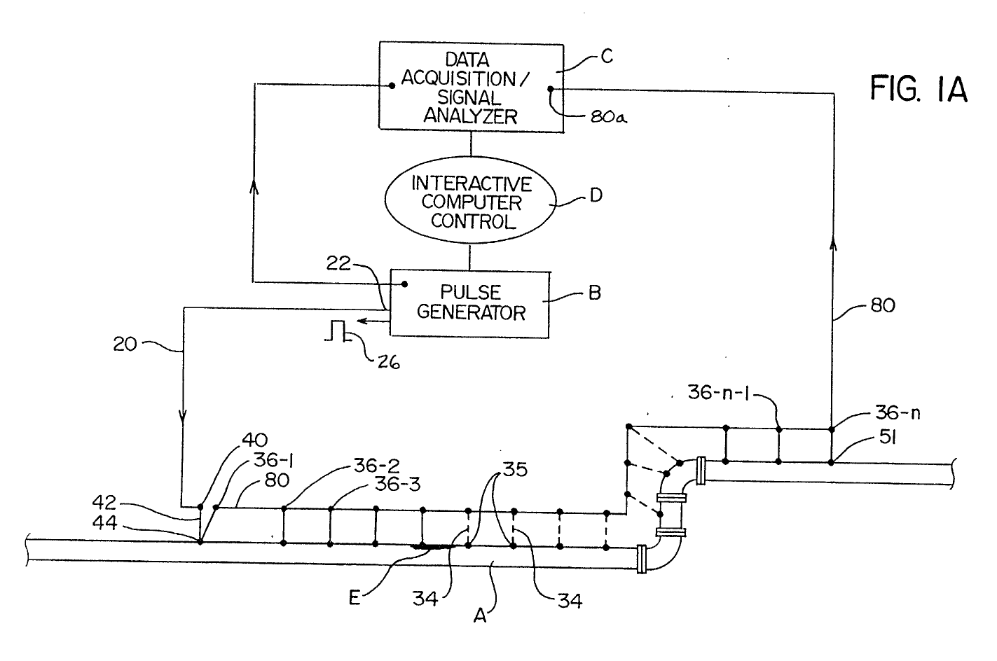

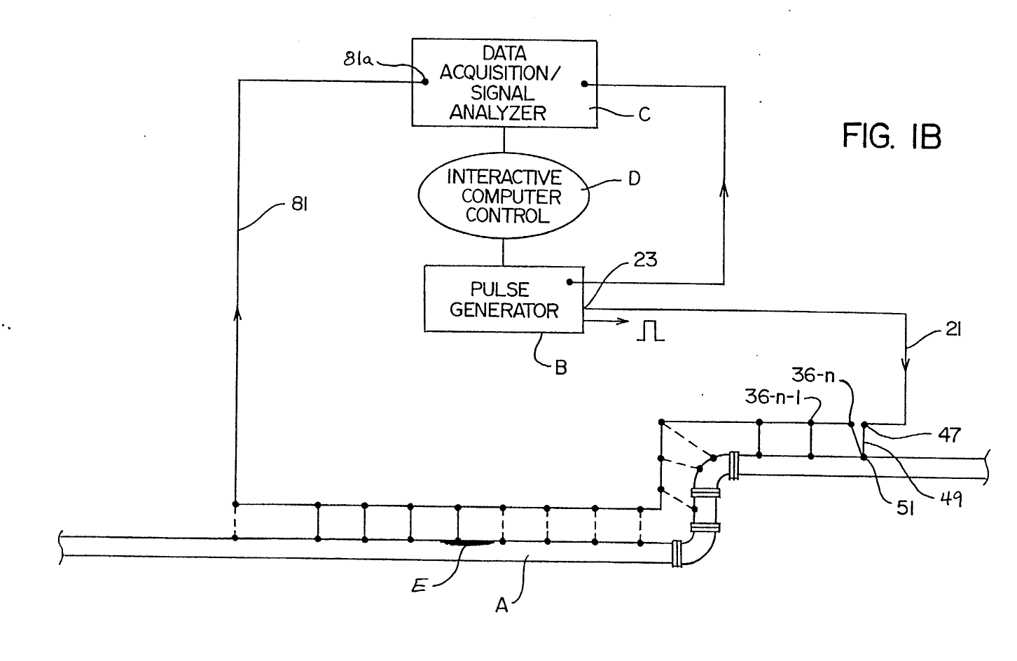

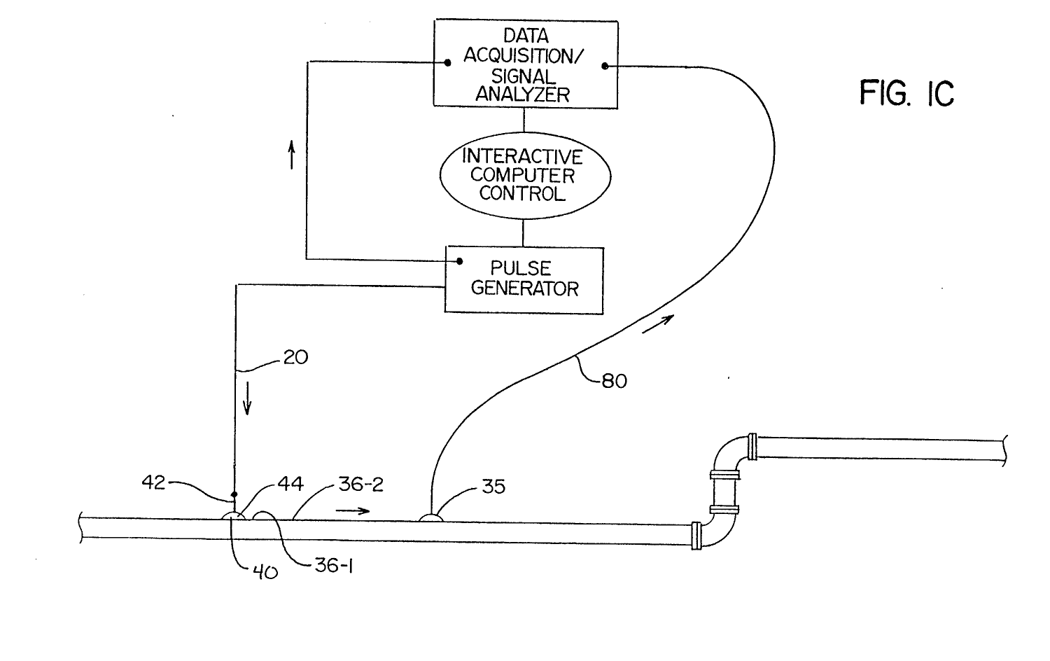

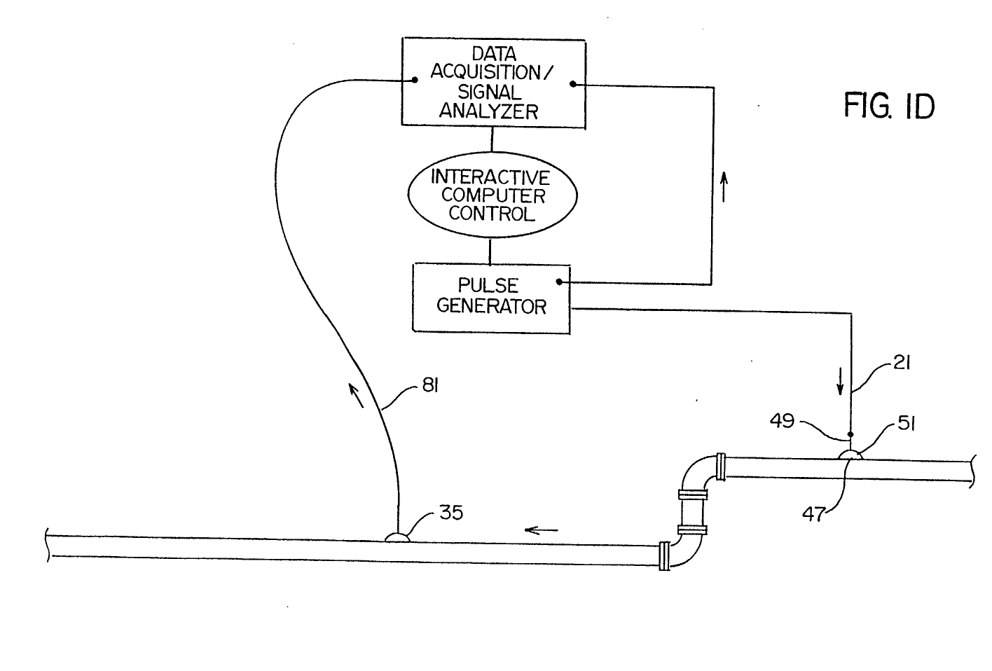

FIGS. 1A, 1B, 1C, 1D, 2A, 2B, 3A, and 3B are basic schematic diagrams of the System of the present invention being in its operative position where it is being used in testing, as an example, a segment of an insulated and shielded pipe or pipeline, beginning with a multi-channel receiving cable. All the other relevant figures pertaining to the present invention are all included herein.

The present invention is applicable to global and detailed detection of anomalies such as corrosion and/or defects in a pipe or pipeline in terms of the integrity of a segment of a pipe or pipeline under test as a whole, or to the location and the degree of its corrosion and/or defects in detail, respectively. In the sequel, anomalies such as corrosion and/or defects are referred to as “corrosion,” and corrosion under insulation and shield in a pipe or pipeline as “CUI.” Global detection is here referred to as detecting the overall integrity of an extended length of pipe, say greater than 25, 50 . . . , hundreds, or even thousands of feet in length, and rank the overall integrity of the pipe or pipeline in I, II, III and IV, ranging from good, average, poor and very poor respectively.

Detailed detection is here referred to as detection of the location of corrosion within +/− two feet and the degree of corrosion in terms of their severity to be classified into A, B, C, and D, ranging from good, moderately corroded, corroded, and severely corroded in the pipe or pipeline in question.

A. Global Detection

With reference to FIGS. 1A and 1B, for global detection of corrosion, the source is placed at the ns (near-side) or fwp (forward-profiling) position and the only receiver is placed at the fs (far-side)or rvp (reverse-profiling) position of the pipe or pipeline. The source is an electric pulse of an optimal width, which is generated by a pulse generator. The electric pulse excites the source cable and is propagated through the source cable, and in turn is transmitted along the pipe or pipeline as an electromagnetic pulse (or waves) to be received at the fs or rvp position. It is understood that the propagation of an electric pulse through the cable and the pipe or pipeline no longer in the classic sense remains an electric pulse but an electromagnetic pulse, as the electric and magnetic fields are always coupled in a medium other than in an idealized free space. For establishment of a reversed profile, the measurement is then reversed, i.e., the transmitter is now located at the fs or rvp position and the only receiver is placed at the ns or fwp position. Again, if the source transmitter and the receiver are located exactly in line longitudinally, the first arrival of the electromagnetic waves will take a straight-line path parallel to the axis of the pipe or pipeline. For global detection, the subsequent arrivals will all take helicoidal paths; the number of turns of the helicoidal paths depend upon the mode of the propagation of the electromagnetic waves. There are no measurements taken between the ns or fwp and the fs or rvp positions for global detection.

B. Detailed Detection

For detailed detection of corrosion in a pipe or pipeline, the source or transmitter is first placed at the ns or fwp position and the receivers are placed in a regular, irregular or combination off regular and irregular n intervals between the ns and the fs positions.

For the ns or fwp operation, the transmitter at the ns or fwp position is excited by an initial electric pulse, which is transmitted through the source cable, and the receiving antennas are directed at the pipe or pipeline with reference to the ns or fwp position as the nearest channel and the fs or rvp position as the furthermost channel. The numbering system of the n channels between the ns or fwp and fs or rvp positions, therefore, is preferably in sequence for the convenience of tracking, while the first channel is at the ns or fwp position and the n-th channel is at the fs or rvp position. The rest of n-2 . . . channels are distributed between the ns or fwp and the fs or rvp positions.

For the fs or rvp operation, an identical transmitter for the ns or fwp operation is then excited at the fs or rvp position for an initial electric pulse generated from a pulse generator. The numbering system of the n channels remains unchanged except measuring starts from the nth channel at the fs or rvp position backward toward the first channel at the ns or fwp position.

For global as well as detailed detection of corrosion in a pipe or pipeline, reference pipes or pipelines are generally given, about which the detailed conditions of corrosion are known. Under the same given environment, the overall integrity and the detailed location and degree of the localized corrosion of the pipes or pipelines in question are calibrated against these reference pipes or pipelines.

2. Embodiment one: Single-pulse/multi-channel Receivers

With the preceding introduction, and reference to FIGS. 1A and 1B, there is shown a segment of the pipe A which is under test. In this instance, this segment of the pipe A may be a section of a pipe or a pipeline that would typically be used in the petroleum, chemical, utility, petrochemical, and/or the like industry, where the pipe or pipeline is made of carbon steel and surrounded by a coat and/or a layer of insulation and a layer of aluminum, galvanized steel, or other metallic shield.

The apparatus or system of the present invention is generally designated for the ns (nearside) or fwp (forward profiling) operation (FIG. 1A), and the fs (far-side) or rvp (reversed profiling) operation (FIG. 1B). It comprises a pulse generator B, a data acquisition/signal analyzer (D/S) C, an interactive computer D, and a source cable 20 or 21, and a multi-channel receiving cable 80 or 81. The source and receiving cables can be electric but they must be highly radiation shielded in order to avoid mutual interference and high energy loss primarily due to radiation. In the sequel, it is completely understood that all the cables, either the source, receiving, or any other cables including all the leads, used in conjunction to the present invention, all are of highly radiation-shield type with a minimum radiation loss.

A. For the Ns or Fwp Operation

Reference is first made to FIG. 1A to describe this mode of operation. A triggering pulse from the pulse generator B first triggers the acquisition/signal analyzer C to provide the initial activation time of an electric pulse to be generated by the pulse generator B. The source cable 20 is a single—conductor cable with one end 22 being connected to the pulse generator B. A prescribed optimal electric pulse with a low repetition rate either a wide-open width pulse or a very narrow pulse width 26 excites the end of the source cable at 22 and is then propagated from the end 22 through the cable 20 to the termination of the cable 40, which is connected to the transmitter 44 with a radiation-shield electric lead 42. In the present invention the transmitter 44 can be a switch-on/off supermagnet or a directional antenna. It can be any other fidelity devices, such as cross-dipole, two-component dipole, or various specially designed antennas, etc. The contact of the transmitter to the pipe or pipeline A is made by the removal of a small area of the insulated cover-from the pipe or pipeline. For the switch-on/off supermagnet type of transmitter, the contact surface of the steel pipe or pipeline in a dimension of 2 inches×2 inches is roughly polished to insure a good contact with the super magnet when it is turned on. For the transmitting antenna type of transmitter, there is no need to have the surface of contact on the pipe or pipeline A prepared.

The receiving cable 80 is a multi-channel electric cable, which is connected to the D/S C. The interactive computer D has operative control connections to both the D/S C and the Pulse generator B as shown in FIG. 1A.

The receiving cable 80 thus has n connecting ports, 36-1, 36-2, . . . 36-n, which are spaced in n intervals along its length. The n receivers, each of which is either a single directional antenna 35, or a group of directional antennas 35, are directed at the pipe or pipeline A in corresponding n intervals. Each antenna 35 has a lead 34, which is connected to the respective connecting port of the receiving cable 80, namely, 36-1, 36-2, . . . 36-n along the length of the pipe or pipeline A under test. As indicated above, this cable 80 is a multi-channel cable and has a plurality of discrete wires, one for each channel, extending along its entire length, with each wire in the cable 80 being connected electrically to the steel pipe directly by a special sensor such as the switch-on/off supermagnet or indirectly by such as an antenna device.

In the present embodiment of detecting CUI, the receiving sensors or receivers are either directly placed on the very external metallic shield of the pipe or pipeline, or indirectly by directing the directional antenna 35 or a group of the directional antennas 35 at the pipe or pipeline A without stripping off any insulation.

In describing the operation of the present invention, a ns or fwp position 44 and a fs or rvp position 51 are established as the starting receiving position 44, and the end of the receiving position 51 of the segment of the pipe or pipeline under test, respectively. In the somewhat simplified drawing of FIGS. 1A and 1B, there are shown only a few contact points. For purpose of description, some of these contacts have been given sequential numerical designations (36-1, 36-2, 36-3, etc.).

In operation, an electric pulse of a predetermined optimum width and an optimal repetition rate is generated by the pulse generator B, from the point 22 is propagated through the source cable 20, and is applied to the transmitter 44 at the ns or fwp position as the source excitation of the pipe or pipeline A. This pulse, now the electromagnetic pulse (or waves), is propagated through the source cable 20, then travels along the pipe or pipeline past the various receiving connecting points 36 along the length of the pipe segment under test. This signal is then received by the receiving sensors, namely, the passive antennas 35 at the various connecting locations 36-1, 36-2 36-n and recorded digitally through an A/D converter by the D/S C and preprocessed. The recording will be multiplexed and subsequently demultiplexed. The manner in which these signals are received, processed and analyzed will be described later herein.

To discuss the operation of this System further, let it be considered that an electromagnetic pulse, after the electric pulse transmitted through the source cable to become the electromagnetic pulse (or waves), is to be received at the receiving point 36-1 which is precisely at the ns or fwp position of the transmitter 44, i.e., the position of the receiver coincides with that of the transmitter. The D/S C, which is being controlled by the interactive computer D, is set so that it will respond to the signal coming through the first channel of the multi-channel receiving cable that is connected to the contact point 36-1. As the transmitter 44 emits an electromagnetic pulse (or waves) at the ns or fwp position and is immediately received by the receiver 36-1 without any time delay. Actually there is a very minute time delay, because the receiver can only be placed adjacent to the transmitter, unless the transmitter can also function as the receiver at the same location. The electromagnetic pulse, which is emitted by the transmitter, is then propagated along the pipe or pipeline A forwardly toward the fs or rvp position and backwardly in the opposite direction. Only this propagating pulse toward the fs or rvp position pulse is received along the pipe or pipeline at the-receiving points 36-1, 36-2, 36-3, . . . 36-n, respectively. Each channel has its own electric cable.

For purpose of description, a given single channel of the multi-channel cable 80 shall be considered as comprising several sections. It must be viewed that the source cable 20 is independent of the receiving cable, which in the present case is the multi-channel cable 80. Once the initial electric pulse is generated from the pulse generator B, it is transmitted into the cable at 22 and through the source cable 20 to the transmitter contact point 44. As the electromagnetic pulse impinges on the pipe or pipeline A, it is propagated along the pipe or pipeline A through the cable 80 to the D/S C at 80a. This pulse is sensed by all the receivers distributed along the pipe or pipeline A under test. As the D/S C is set, it is responsive to the signal received at the receiving points, 36-1, 36-2 . . . 36-n. The received signals from each channel are transmitted through each respective channel of the multi-channel cable 80 and, in turn, transmitted to the D/S C to be recorded; the information will also be transmitted to the interactive computer D.

B. For the Fs or Rvp Operation

Reference is made to C to describe this second mode of operation. With this above described process having been completed, then the same process is repeated, but in its reverse (FIG. 1B). More specifically, an electric pulse is now generated from the pulse generator B, which is propagated through the source cable 21 to the end of the cable 47. The end 47 of the source cable 21 is connected to the transmitter 51, which is an active source antenna with an electric lead 49 for the reversed profiling operation. As before in the ns or fwp operation, the pulse generator B triggers the D/S C and in turn to activate the initial time of the electric pulse.

Thus, the electric pulse is delivered from one of the ends of the cable 23, which is connected to the pulse generator B. The pulse is propagated through the source cable 21 and excites the pipe or pipeline by the transmitter at the fs or rvp position 51. The D/S C is set so that it responds to the pulse, which is sensed by the receiver at the receiving point 36-n, which is now at the fs or rvp position 51. The pipe or pipeline A at the contact point 51 is similarly prepared as in the ns or fwp operation for the mounting of the source transmitter; for instance, as previously described for the ns or fwp operation, mounting of a switch-on/off supermagnet or a transmitting antenna. Thus, this pulse, as an electromagnetic pulse (or waves), is propagated through the source cable 21 into the pipe or pipeline A. It is then transmitted along the pipe or pipeline A at the receiving contact points 36-n, 36-2, 36-1 in the reverse order of that for the ns or fwp operation. And it is transmitted through its respective channel, through the intermediate cable section 81 and thence travels through the cable section 81 to the receiving point 81a and thence into the D/S C to be recorded. The data acquired and the information developed by the D/S C relative to this pulse are then transmitted to the computer D and stored.

Thus, as described above, the receiving locations 36 are stepped along the length of the pipe or pipeline proceeding from a location at the receiving contact points, 36-n at the fs or rvp position 51 all the way to the initially starting contact, point 36-1, which is at the ns or fwp position.

3. Embodiment Two: Single-pulse and Single-channel Receiver

This second embodiment will be described with reference to FIGS. 1C and 1D. Because of certain operational restrictions, field measurements sometimes call for a single-conductor single-channel receiving cable, as shown and described in this second embodiment.

For both the ns or fwp operation and the fs or rvp operation, the operational procedure basically remains the same as in the first embodiment where there is used a multi-channel receiving cable, except that a single-channel receiving cable 80 is used in place of the multi-channel receiving channel. Thus, the single-channel receiving cable is now only able to handle one receiving location at a time. It is now necessary that this single-channel receiving cable be moved each time after each measurement at each receiving location.

As in the first embodiment two single-conductor source cables 20 and 21 are still used as the source cables for both the ns or fwp and the fs or rvp operations, respectively. A switch-on/off supermagnet or a directional antenna 44 or 51 is affixed to the end of the source cable at the connecting points 40 or 47, through the leads, 42 or 49, respectively. As a precaution, the source cable is separated from the receiving cables as far as possible at a permissible distance. For the ns or fwp operation, the transmitter 44 is thus positioned at the ns or fwp position, but there is only one receiving antenna 35, which is positioned at the end of the receiving cable 50. This receiving antenna 35 is physically moved at sequential increments of distance starting from the ns or fwp position toward the fs or rvp position.

For example the antenna 35 can be first positioned at point 36-1 to receive a signal from the electromagnetic source pulse, moved then to point 36-2, next point 36-3, etc.

For the fs or rvp operation, the transmitter is positioned at the fs or rvp position while the receiving antenna, which is positioned at the end of the receiving cable, is moved from the fs or rvp position backward toward the ns or fwp position at n intervals of distance.

The single-conductor single-channel receiving cable 80 for the ns or fwp operation and the receiving cable 81 for the fs or rvp operation are used, respectively. One end of the receiving cable is connected to a receiving antenna, and the other end is connected to the D/S C for either the ns or fwp or the fs or rvp operation, respectively. For the ns or fwp operation, the source is located at the ns or fwp position, 44 and (as indicated above) the receiving antenna is moved forward along the pipe from the ns or fwp position 36-1 which coincides with the position of the transmitter 44 to the fs or rvp position 36-n at an n interval of . distance. Then the operation of a reversed profiling is carried out. Now the transmitter excites the pipe or pipeline A at the fs or rvp position and the receiving antenna, after receiving and recorded the signal, is moved backward from the fs or rvp position 36-n toward the ns or fwp position 36-1 at an identical n interval of distance as used in ns or fwp operation of the forward profiling Alternatively, instead of repeating measurements at a receiving location twice, once for the ns or fwp operation and the second time for the fs or rvp operation, for convenience, the above measuring procedures can be accomplished in one step. When the receiving antenna at a given location is completed for the ns or fwp operation, the receiving antenna is kept at the same receiving location acting as the receiver for the Fs or rvp operation. Therefore, the receiving antenna at a given receiving location needs to be moved only once to accomplish both the ns or fwp and the fs or rvp operations.

4. Embodiment Three: Single-pulse and Multi-channel

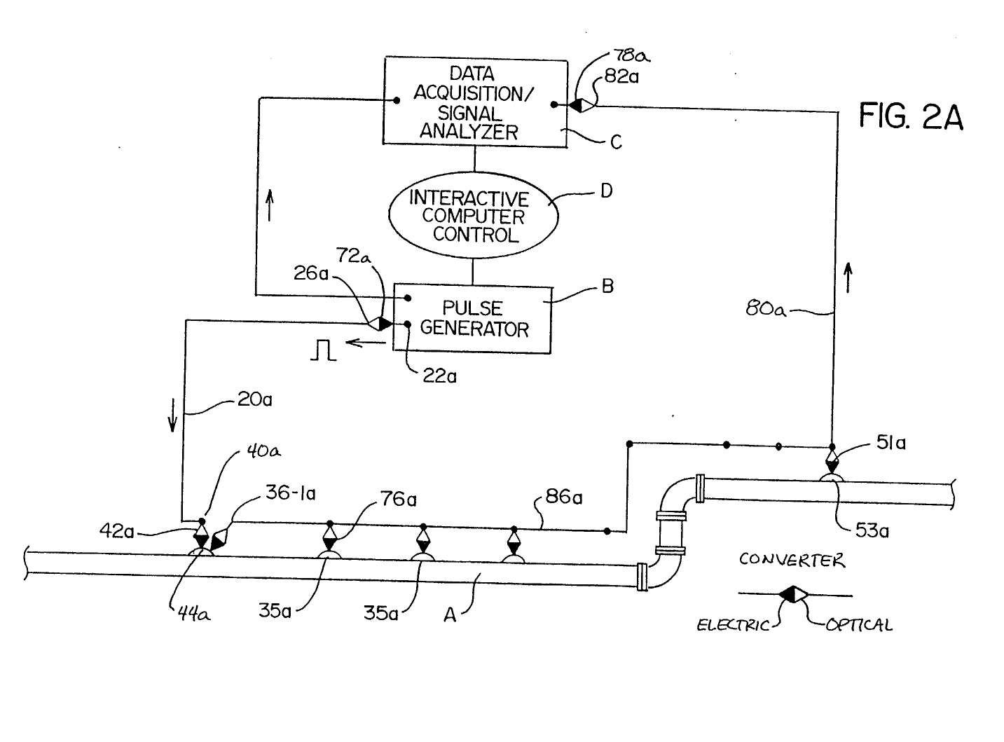

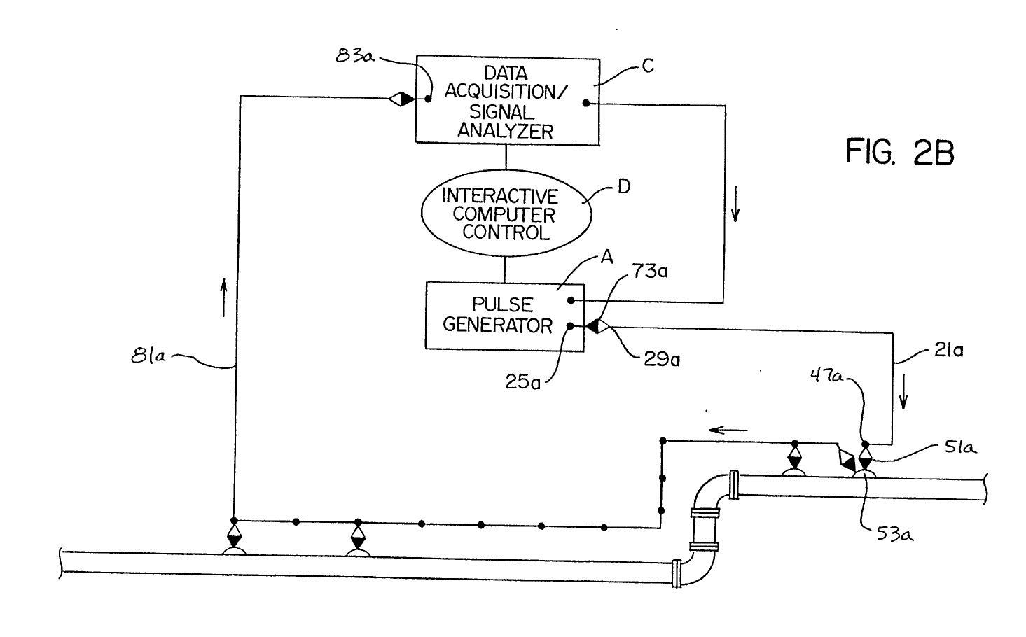

Receivers with Fiber-Optical Source and Receiving Cables Reference is now made to FIGS. 2a and 2b. To provide further reduction of the electromagnetic radiation and interference due to the source and receiving cables, in this third embodiment two single-channel fiber-optical source cables and a multi-channel fiber-optical receiving cable can be used. However, an electrical-to-optical converter and an optical-to-electrical converter are needed at every junction of the electrical cable and the fiber-optical cable wherever a fiber-optical cable replaces an electrical cable as shown in FIGS. 2a and 2b, which are to be compared with FIGS. 1A and 1B, respectively. Notice in FIGS. 2a and 2b that the electrical cables are replaced by the fiber-optical cables.

Components of Embodiment Three which are similar to components of Embodiment One and Two, except the electrical source and electrical multi-channel cables, are now replaced by the fiberoptical source cable and the fiberoptical multi-channel receiving cables, respectively. One will be given like numerical designations, with an “a” suffix distinguishing those of Embodiment Three. This third embodiment comprises essentially a pulse generator B, a data acquisition/signal analyzer (D/S) C, and also an interactive computer control D, which remain unchanged. However, instead of having (as in Embodiment One and Two) a multi-channel cable 80 having a plurality of discrete electrical wires, there is provided a ns or fwp profiling multi-channel fiber-optical receiving cable 80a extending between the connecting location 36-1 to the connecting location 82a. Also, there is a fs or rvp profiling fiber-optical receiving multi-channel cable section 81a extending from the end location 83a to the connecting location 47a.

The two source cables 20a and 21a are now made as fiber-optical cables. Between the fiberoptical source cable 20a and the connecting location 40a, there is provided an optical-to-electric converter, which is mounted on the upper plate of the four-post standoff of the transmitting antenna schematically shown as 42a that converts the pulse or signal from the fiberoptical cable 20a to an electrical signal which excites the transmitting antenna 44a. Also, there is an electrical-to-optical converter 72a between the points 22a and 26a.

As Embodiment One and Two, a triggering pulse from the initial pulse generator B triggers the D/S C to initiate the activation time of the electric pulse.

The initial electric pulse is transmitted from the point 22a of the pulse generator B and is converted by the electrical-to-optical converter 72a to an optical pulse or signal that travels through the source cable 20a to be converted back to an electrical pulse by an optical-to-electrical converter, which is mounted on the top of the transmitting antenna marked as 44a. In turn, this electromagnetic pulse is received by the receiving antennas 35a, along the pipe or pipeline, from 36-1A, 36-2a, . . . 36-na, each of which has an electrical-to-optical converter 76a on the top of the receiving antenna, and again converts the electromagnetic signals to optical back to the optical multi-channel optical receiving cable 80a to be transmitted to an electric-to-optical converter 78a which is connected between each channel location 36-1A, 36-2a, . . . 36-na individually and the optical cable section 80a and back to the D/S C.

In like manner, during the fs or rvp operation, the electric pulse from the pulse generator B is converted to a fiber-optical signal by an electric-to-optical converter 73a that is between the points 25a and 29a. The fiber-optical signal travels through the fiber-optical cable section 21a to the optical-to-electric converter 51a, which is mounted on the top of the transmitting antenna 53a. The manner in which the rest of the process is accomplished is substantially the same as described above with respect to the fs or rvp operation as in the ns or fwp operation so this will not be described further herein.

However, it is fitting to mention that it is also feasible that all the data be transmitted and recorded as a data string through a single fiber-optical cable rather than each channel having its own separate cable. The data acquired and the information developed by the D/S C from the receivers are then interactively communicated to and stored in the computer D.

Embodiment three may under certain circumstances provide certain advantages. For example, by the use of fiber-optical cables, the effects of creating unwanted electromagnetic interference due to mutual induction, radiation, and coupling are effectively minimized or eliminated.

5. Embodiment Four: Single-pulse and Single-channel

Receiver with Fiber-Optical Source and Receiving Cables Both the ns or fwp operation and the fs or rvp operation of the present embodiment is exactly identical to as Embodiment Two, except the electrical source and receiving cables are now replaced by the fiber-optical source and the fiber-optical receiving cables. The components of the hardware, including the pulse generator B, the data acquisition/signal analyzer D/S C, and the interactive computer D, remain unchanged. With reference to Embodiment Three, the only difference is that the optical multi-channel receiving cable of Embodiment Three is now an optical single-channel receiving cable. Moreover, the locations of the converters, the electrical-to-optical and optical-to-electrical, also remain the same as shown in FIGS. 2a and 2b.

Therefore, for both the ns or fwp and the fs or rvp operations, the optical single-channel receiving cable is moved upon completion of each measurement.

6. Embodiment Five: Dual-pulse and Single-channel Receiver

Embodiments One through Four are all dealing with the single-pulse techniques that are based on the excitation of a single source pulse. For example, the transmitter used is either a switch-on/off supermagnet, which is directly affixed to the pipe or by a high-pass directional antenna directed at the pipe or pipeline under test.

Embodiment Five here is dealing with an improved dual-pulse technique, while its basic concept remains unchanged. (See U.S. Pat. No. 4,970,467, issued in Nov. 13, 1990).

In the earlier version of the dual-pulse techniques, the intersection of the two traveling pulses from the ns or rvp position and from fs or rvp position along the pipe or pipeline A was established at either ns or fwp position or the fs or rvp position, where the supermagnet was mounted.

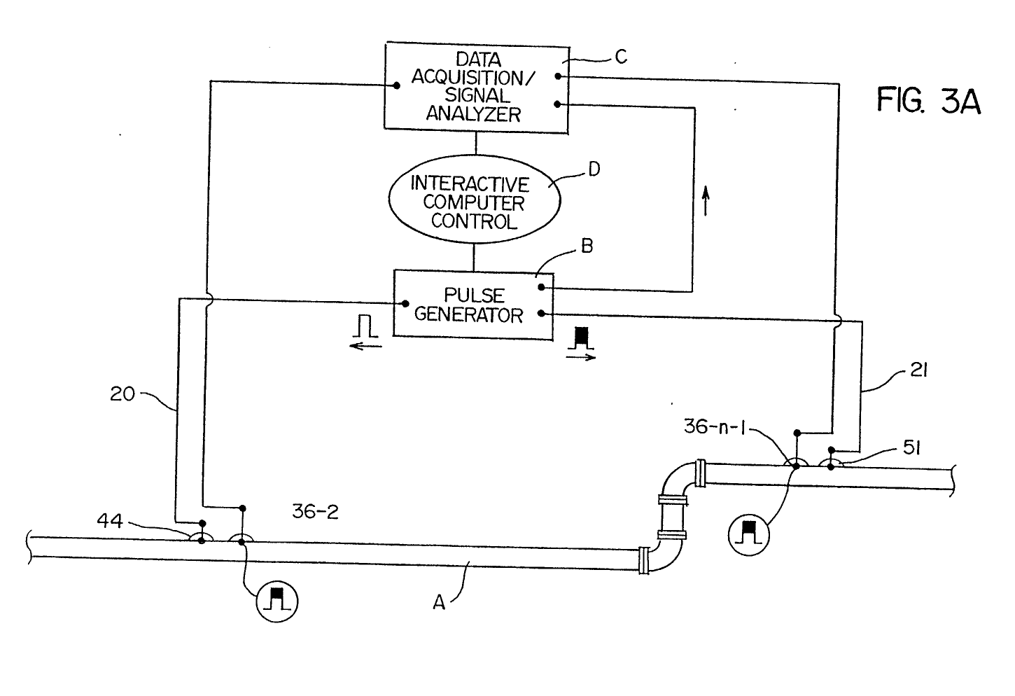

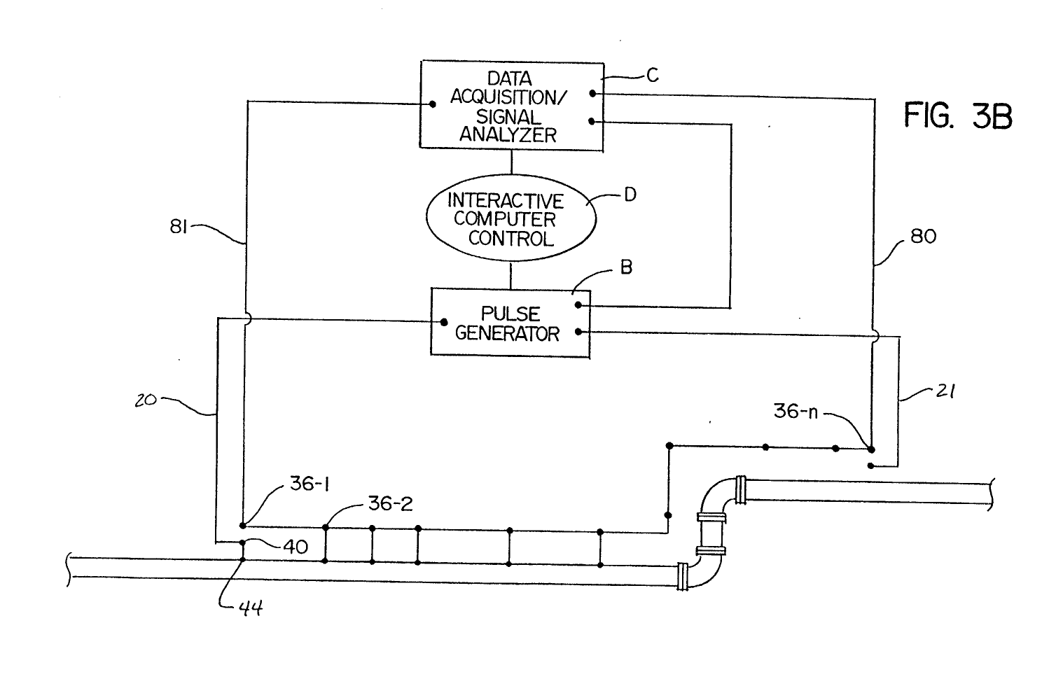

In the present improved dual-pulse technique, as shown in FIG. 3A, for efficiency, the two identical source transmitters at the ns or fwp 44 and the fs or rvp 51 positions of the pipe under test now can use either a switch-on/off supermagnet or a directional antenna. Furthermore, by using a directional antenna, the receiving signals at the location of the two-pulse intersections between the ns or fwp and the fs or rvp potions can be tapped so that experimentally the wave forms of the effect of the intersection can be observed.

The following gives a detailed description of the improved dual-pulse techniques.

As in Embodiments One through Four, a triggering pulse is delivered from the pulse generator B to trigger the D/S C so that the initial time of activation of an electrical pulse to be generated by the pulse generator B is referenced.

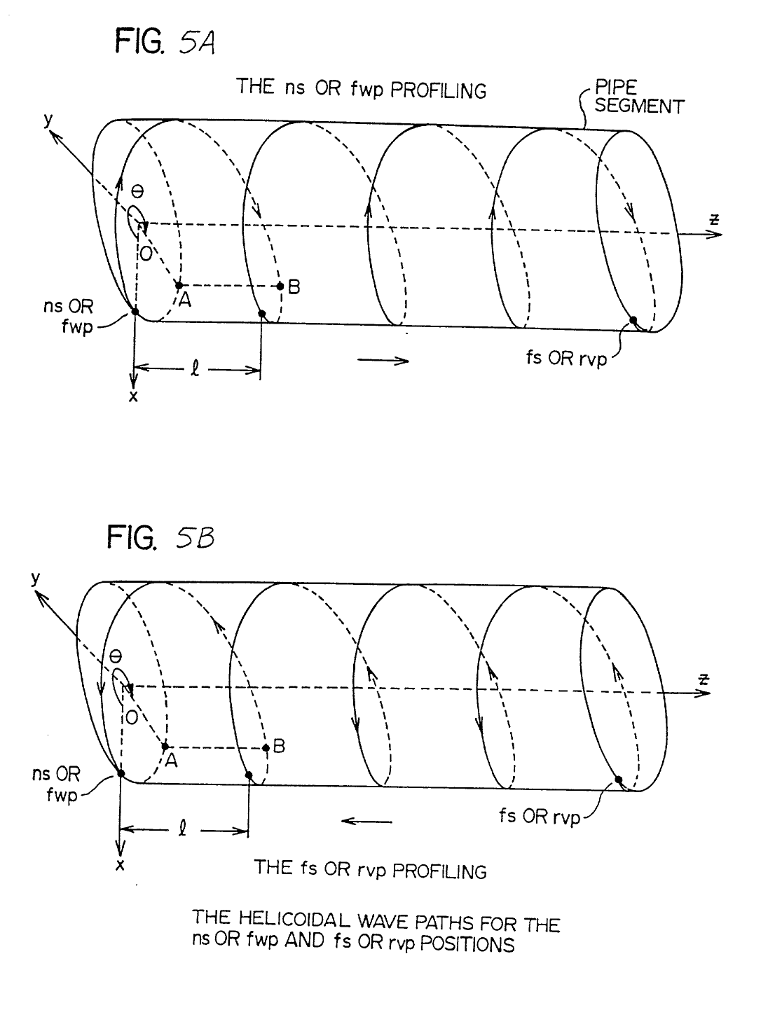

For global and detailed detection, two identical transmitters at the ns or fwp and the fs or rvp Positions 44 and 51, respectively, are simultaneously excited but any time delay, thus, can be imposed on either of the two sources at 44 and 51 to allow the two pulses to be propagated in the opposite directions within the segment of the pipe or pipeline A under test to intersect at any desired locations along the pipe or pipeline. These two source transmitters can be two high-pass transmitting antennas (See FIGS. 5A and 5B) developed concurrently for the present invention, or two switch-on/off supermagnets. A directional receiving antenna can be directed at the pipe or pipeline A anywhere between the ns or fwp and the fs or rvp positions. In practice, the receiving antenna is preferably to be located close to, or at the center of the source positions 44 and 51, for the fs or rvp operation and the ns or fwp operation, respectively.

For the ns or fwp operation, an initial intersection of the two identical but oppositely propagated pulses at the location of the receiving antenna, say at 36-n-1, is first established by adjusting the time delays of the two electromagnetic pulses, which are transmitted through the source cables 20 and 21 to the transmitters at the locations 44 and 51. Once the initial intersection of the two pulses is established at the receiving location, 36-n-1, the time delays for the two transmitters at the ns or fwp and the fs or rvp positions are thus fixed. Data are taken of the wave forms, including the first and subsequent arrivals, at the receiving location 36-n-1 each time by an incremental decrease of the time delay for the transmitting electromagnetic pulse from the ns or fwp position so that the two electromagnetic pulses would be intersecting between the transmitting location at the ns or fwp position and the receiving antenna location 36-n-1.

For the fs or rvp operation, the operation is then reversed and the same procedure repeated, the receiving antenna is now moved to the receiving location, say 36-2, to find the intersection of the two electromagnetic pulses which are propagated from both the ns or fwp transmitting position and the fs or rvp transmitting position.

Then the delay times for both the fs or rvp position and the ns or fwp position are fixed exactly at the time of the two pulses intersection at the receiving location 36-2. Data of the wave forms are then taken at the receiving location 36-2 by a desired incremental decrease of the time delay of the electromagnetic pulse propagated from the fs or rvp position toward the ns or fwp position such that the intersections of the two pulses would be between the fs or rvp position and the receiving location 36-2.

It is apparent that the dual-pulse operations in Embodiment Five for a single-channel receiving cable assume that the two electromagnetic pulses would intersect at the prescribed location. If the conditions of corrosion are complex, containing a variety of irregular distribution of corrosion within the segment of the pipe or pipeline under test, the precise location of the intersections of the two electromagnetic pulses at a given location could be shifted from the expected location of the intersection.

Thus, as an alternative to obtain greater precision, a multi-channel receiving cable can be used to replace the single-channel receiving cable 80 or 81 (FIG. 3b). Data can be taken, if desired, at every receiving location as designated between the ns or fwp and the fs or rvp positions. The intersections of the two electromagnetic pulses can be observed precisely. As required, the intersections of the two electromagnetic pulses on the basis of observation can now be adjusted by the interactive computer B by means of the time delays of the two electromagnetic pulses. The actual intersection of the two electromagnetic pulses would give the precise information for evaluation of the location and the degree of corrosion in the segment of the pipe or pipeline A under test. It is clear that at every receiving location, a data set of the intersection time of the two pulses along the pipe or pipeline at an incremental time delay are provided. These time delays of the intersection can be translated into distances for identification of the location and the degree of corrosion along the segment of the pipe or pipeline. Therefore, all the data sets for all the receiving locations would provide the redundant sets of data, which can be stacked and manipulated according to the locations of the receivers and the intersection times to yield the travel time information and the modification of the wave forms due to corrosion.

The operational procedures for a multi-channel receiving fiber-optical cables for both the ns or fwp and the fs or rvp operations are exactly similar to the single-channel receiving cable as in Embodiment Five, not to be re-described herein.

7. Embodiment Six: Single Pulse and Two Ended Multi-channel Receiving Cable

Furthermore, the multi-channel receiving cable can be made into a two-ended receiving cable. Since the multi-channel receiving cable 80 or 81 is a passive receiving cable, which can be made into a two-ended cable with multi-channel connecting ports in the middle (See FIGS. 1A and 1B). One of the ends extends from the multi-channel cable 80 to the D/S C, while the other end extends from the multi-channel cable 81 to the D/S C. For the ns or fwp operation, the transmitter excites the pipe or pipeline at the ns or fwp position 44 so that the electromagnetic pulse, which is originated from the pulse generator B and propagated through the source cable 20, is propagated along the pipe or pipeline under test. The receivers, which are located at 36-1, 36-2, . . . 36-n along the pipe or pipeline, sense the signals. The D/S C is then set and records the signals for each receiving location through the channel cable 80. For the fs or rvp operation, the test settings for the ns or fwp operation remain the same. Now, instead the electromagnetic pulse, which is originated from the Pulse generator B and propagated through the source cable 21, is propagated along the pipe or pipeline in the reversed direction from the ns or fwp operation. The receivers, which are located at 36-n, 36-(n-1), . . . 36-1, sense the electromagnetic signals. The D/S C is set for recording the signals for each receiving location through the receiving channel cable 81 in the reversed order.

8. Travel Time and Wave Forms or Wave Trains

It should be understood that the various components of the System would have previously been calibrated so that each relevant time increment in the system has already been predetermined. For example, with reference to FIGS. 1A and 1B, the time during which the pulse generator B generates a pulse at 22 and this pulse arrives at the connecting point 44 would have already been precisely measured, and this information is stored in the computer D. Also, the time interval at which a signal is received at each and every one of the receiving contact locations 36-1 through 36-n to the receiving contact point 80a and through the section 80 to the D/S C would have already been precisely measured and is also stored in the computer D.

Therefore, when the pulse is generated at 22 to travel into the transmitting point 44 and received at the connecting point 36-1, the total time lapse from transmitting the pulse 22 to the time when it was received at the D/S C is measured. Of course, the travel time between the transmitter 44 and the receiving point 36-1 is just zero, as the receiving location at 36-1 coincides with that of the transmitting location 44. It is possible to determine the precise time interval during which that pulse has traveled from the contact point 44 along the pipe or pipeline A and to all the receiving locations, 36-1, 36-2, . . . 36-n.

To carry this analysis further, let it be assumed that the receiving contact point 36-2 is now in operative connection to the D/S C, so that the pulse now travels through the source cable 20 to be received at the ns or fwp position 44 can be determined, and the time interval which it takes a pulse to travel that distance from 36-1 to 36-2 can also be determined. The velocity of the pulse traveling through any particular section of pipe between the adjacent receiving locations, 36-1 and 36-2, 36-2 and 36-3, etc. can also be precisely determined.

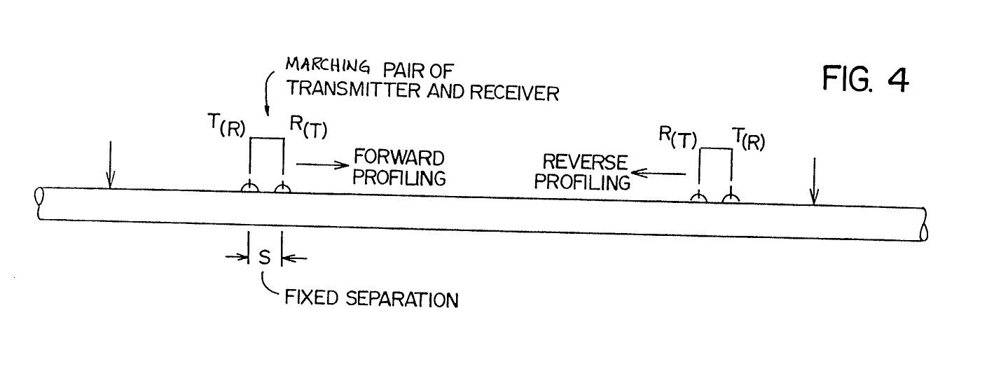

As an alternative, the difference of the electromagnetic wave propagation between two adjacent locations such as the above described, viz., the travel time and wave form differences between 36-1 and 36-2, 36-2 and 36-3, . . . 36n-1 and 36-n can be directly measured by employing a pair of directional antennas, one acting as the transmitting source antenna and the other acting as the receiving antenna. Since the transmitting and the receiving antennas are essentially identical, they can be interchanged in the profiling. They can be reversed, i.e., the source antenna acting as receiving antenna and the receiving antenna acting as the source antenna. For the ns or fwp and fs or rvp operations, the pair of transmitting and receiving antennas can be configured as a marching pair as shown in FIG. 4.

This marching pair of the source and receiving antennas has a separation between the two antennas from a few inches to several feet. Normally, the separation of the marching pair can range at least from one to five feet for a conservative resolution of detecting corrosion of about one to two feet in length.

From the description of the operation of the System as given above, it now becomes apparent that the System of the present invention is possible to determine the time interval which it takes the pulse to travel through the segment of the pipe or pipeline under test from the transmitting contact point 44 to each of the receiving contact points 36-1 through 36-n. In like manner, for a reversed profiling, it is also possible to determine the length of the time interval that it takes the pulse to travel from the transmitting contact point 51 through the pipe or pipeline A to each of the receiving contact locations in a reversed order to 36-n all the way through 36-1 (FIG. 1B).

Further, the distance between each adjacent pair of contact points 36-1 through 36-n would have been precisely measured. Thus, since the distance between each set of contact points, for example 36-1,36-2, 36-2 and 36-3, etc. can be determined, and the time interval which it takes a pulse to travel that distance can also be determined, the velocity of the pulse traveling through any particular section E pipe or pipeline between the adjacent receiving locations, 36-1 and 306-2, 36-2 and 36-3, etc. can also be precisely determined to yield the information on corrosion, as the velocity for corroded pipes is slightly smaller than that for a non-corroded pipe, which will be further addressed in the sequel. The slowness is then simply 1/velocity. Moreover, as the D/S C is interactively controlled by the computer D, the D/S C thus records not only the first arrivals at all the receiving locations, viz., 36-1, 36-2, . . . 36-n, for the ns or fwp operation, and 36—n, 36-n-1, . . . 36-1 for the fs or rvp operation that provide the travel time information for a reversed profile, but also all the wave forms or wave trains of a designated length of the record for each channel that provide additional information on the dynamic aspects of the characteristics of the electromagnetic waves, in terms of propagation, attenuation, dispersion, etc., as these waves are propagated along the pipe or pipeline under test.

9. Physical Phenomena for the Present Invention

A. Dynamic Characteristics

With the basic operation of the System having been described above, let us now present the underlying phenomena involved which enables this system to be effectively utilized to detect corrosion and/or defects, and/or or other anomalies in a pipe or pipeline A or the like. The System of the present invention uses a time-domain electromagnetic pulse as an excitation source and takes advantage of the fact that external corrosion on a pipeline changes the characteristics of electromagnetic wave propagation, including velocity (or its inverse, slowness), attenuation, dispersion, and phase shift. The System could be applied to detect a variety of corrosion which occur on the surface of the pipe or the pipeline under insulation.

The technique utilized in the System of the present invention has been designated by the inventors as “True Electromagnetic Waves” (abbreviated to “TEMW”, a trademark). The propagation of a electromagnetic pulse about a pipe or pipeline is fundamentally a dynamic electromagnetic phenomenon. It is completely governed by the electromagnetic wave equations, which are derived from Maxwell's Equations.

The following briefs the essential parts of the derivation, in view of the importance of these wave equations, which constitute the essence of the present invention to be applied to the detection of corrosion and/or defects of CUI.

The first two Maxwell's equations and consitutive relations for a linear and isotropic medium are:

$$\begin{matrix}∇ \times E = - \frac{\partial B}{\partial t} , & ( 1 ) \\ ∇ \times H = \frac{\partial D}{\partial t} + J , & ( 2 ) \\ H = \frac{1}{μ} B , & ( 3 )\end{matrix}$$

J=σE, (4)

D=εE, (5)

where

E=electric field in volt/m,

H=magnetic field in A-turn/m,

D=electric displacement in C/m2,

B=magnetic induction in W/m2,

J=electric current in A/m2,

ε=electric permittivity in F/m,

μ=magnetic permeability in H/m, and

σ=electric conductivity in mho/m.

The magnetic induction B and the electric displacement D include the externally imposed source terms μM′ and P′ and are

B=μH+μM′, (6)

and

D=εE+P′, (7)

where the magnetic dipole moment density M′ (A-turn/m) is related to the imposed magnetic current density Jₘ, and the electric dipole moment density P′ (C/m²) related to the imposed electric-current density Jₑ by

$${J}_{m} = \frac{\partial {M}^{′}}{\partial t} , {J}_{e} = \frac{\partial {P}^{′}}{\partial t} . \qquad ( 8 )$$

By taking the curl of equation (1), introducing equation (2), and using the constitutive relations (3), (4), and (5), we obtained the electric field equation. The magnetic field equation is similarly derived.

In the Cartesian coordinate system, we thus have the electric and magnetic field equations, respectively as follows:

$$( {∇}^{2} - ϵμ \frac{{\partial }^{2}}{\partial {t}^{2}} - σ μ \frac{\partial }{\partial t} ) E = {S}^{e} , \\ ( {∇}^{2} - ϵμ \frac{{\partial }^{2}}{\partial {t}^{2}} - σμ \frac{\partial }{\partial t} ) H = {S}^{m} . \qquad ( 9 )$$

where

$${S}^{m} = ( ϵμ \frac{\partial }{\partial t} + σμ ) {J}_{m} - ∇ \times {J}_{e} + ∇ {ρ}_{m}$$

$$and$$

$${S}^{e} = μ \frac{\partial {J}_{e}}{\partial t} + μ \frac{\partial }{\partial t} ∇ \times {M}^{′} + ∇ \frac{{ρ}_{e}}{ϵ}$$

are the EM sources which generate the electric and magnetic wave fields, respectively, and where ρ_{c} (c/m³) and ρm (A-turn/m²) are externally imposed electric and magnetic charges which presuppose that the divergence of the magnetic field is assumed not to be always vanishing.

The importance of the present invention is that we utilize the full field equations of (9) that opposes the traditional approaches to electromagnetics. As stated in the Background Art section of the present application, the present, invention is fundamentally different from those of either Spies or Lara in that Spies and Lara do not deal with the electromagnetic wave propagation and completely neglected the term

$$ϵμ \frac{{\partial }^{2} H}{\partial {t}^{2}} ϵμ \frac{{\partial }^{2} E}{\partial {t}^{2}}$$

of the electromagnetic wave propagation so that theirs are quasi-static dealing with a diffusion field. Inclusion of this propagating term in the development of the present invention thus completely separates the present techniques from those of Spies and Lara, as well as others.

Specifically, the present invention deals with detection of corrosion under insulation (CUI). It is based on the fact that the electromagnetic properties for good, non-corroded steel pipes are different from these for corroded steel pipes. An electric pulse or an electromagnetic pulse may be considered as a superposition of harmonic waves. Each single frequency harmonic wave of a transient electric or electromagnetic pulse is propagated with a phase velocity, while it suffers an exponential attenuation and a phase shift. The complex propagation constant of these harmonic waves in the frequency domain thus consists of the real and imaginary parts, a and b, respectively, given by:

γ=a+ib=(−ω²εμ+iσμ (10)

where

a=ω(εμ/2)^{½}[(1+σ²/ω²ε²)]^{½} (11)

and

b=ω(υμ/2)^{½}[(1+σ²/ε²ε²)^{½}+1]^{½}. (12)

where the phase velocity is

$$υ = \frac{ω}{b}$$

and its slowness is simply u⁻¹, the attenuation constant a, and the phase constant b.

The relative magnitude of conduction current to displacement current is given by the ratio σ/ωε. Of course, the degree of the conductivity σ over the effect of permittivity ε or vice versa on the electromagnetic wave propagation depends upon the frequency and the given values of the two parameters σ and ε. The ratio σ/ωε for a good conductor such as steel pipes whether corroded or non-corroded is much greater than unity. However, because of corrosion, this ratio for a corroded pipe is slightly smaller than for a good pipe that is one of the physical keys to the development of the present invention.

On a corroded pipe, the corrosive material (or product) which deposits on a pipe or a pipeline thus changes both conductivity and permittivity, as well as permeability. However, the change of permeability K1 in this case is relatively minor in comparison with the changes of conductivity and permittivity. The electromagnetic properties, particularly ε and σ, for a good, non-corroded steel pipe are generally higher than those for a corroded pipe. Therefore, the phase velocity of the electromagnetic waves for a good, non-corroded pipe is generally higher than for a corroded pipe. And the slowness is generally lower for a good, non-corrosive pipe in comparison with that for a corroded pipe. The degree of the severity of corrosion determines the deviation of the phase velocity, or its slowness, from that for a good, non-corrosive pipe. Likewise, the attenuation of the electromagnetic waves for a corrosive pipe would be higher than that for a good, non-corrosive pipe. The phase velocity of the electromagnetic waves in a pipe, whether it is non-corrosive or corrosive are of frequency dependence so that the propagation of the electromagnetic waves in a pipe is dispersive, which introduces additional complication in dealing with wave forms.

The above statement of the phase velocity, attenuation, dispersion, and phase shift of the electromagnetic waves is valid for the transient electromagnetic pulse, as previously stated that a transient electromagnetic pulse always can be decomposed into Fourier components in the frequency domain.

B. Skin Depth

The penetration of the electromagnetic waves is controlled by skin depth, or penetration depth, which is somewhat inversely proportional to the conductivity of the medium, in which the electromagnetic waves are propagated, and the frequency of the waves. Accordingly, skin depth becomes smaller for higher frequency in good conductors, such as steel, of which pipe under question is generally made. The conductivities of the steel, HTS and HY-80, at 1 kHz and 20° C., are 4.80 and 3.50 mmho/m, respectively, and the skin depths are 0.54 and 0.90 mm, respectively (taken from Kraichman, 1970, Handbook of Electromagnetic Propagation in Conducting Media: NAVMAT 2-2302, U.S. Govt. Printing Office, Washington D.C, 20402, p.A2). In the present invention, the electromagnetic waves are propagated in range along the steel pipe or pipeline in the hundreds of MHz and GHz range along the steel pipe or pipeline, the skin depth for the steel pipe or pipeline would be far smaller than the above quoted numbers for steel. Therefore, the electromagnetic wave propagation a pipeline is confined to the very surface or virtually the boundary layer of a pipe or pipeline where corrosion occurs.

C. Propagation Paths of Electromagnetic Waves Along a Pipe

The propagation of electromagnetic waves naturally obeys the Fermat's principle.

The first arrival and the subsequent arrivals of the electromagnetic waves about a pipe or pipeline even under insulation follow the shortest travel paths according to Fermat's principle that the first energy travels over the path which takes the least time.

The subsequent energies would travel in the shortest helicoidal paths around the pipe. Therefore, the arrivals of the electromagnetic waves would indicate the condition and degree of corrosion of the pipeline, if the travel paths encounter the corrosion and/or defects to be detailed.

The energy of the source, however, is partitioned. Likewise, there are also energies traveling in the direction away from the receiving locations along the pipe or pipeline.

Whereas electromagnetic waves reflect, refract, and diffract at the interface for example between two sections of a pipe or pipeline, i.e., a good and a corroded section, at the junction of the two different types of pipe, or simply isolated corrosion. Reflection, refraction, and diffraction of electromagnetic waves in general obey the classic laws of Snell, Fresnel, and Huygens.

Furthermore, the traveling path of the electromagnetic waves, which takes the least time depends on the positions of the transmitter and the receiving locations. If the transmitter and the receiver are located longitudinally at a distance but exactly at the same azimuthal angle, say 12 O'clock with reference to the top of the pipe, the first arrival would be a straight line (ray), if we assume a point source and a point receiver. In the present invention, we use a supermagnet or an antenna as the source and an antenna as the receiver, there would be a bundle of rays according to the dimensions of the source and receiver. The circumferential designation of the position of the transmitter and the receiver thus here is referenced clockwisely, facing the ns or fwp position from the direction of the fs or rvp position. Thus, the position of 6 o'clock is located on the bottom of the pipe, and the positions of 3 o'clock and 9 o'clock are located on the right-side and the left-side of the circumference of the pipe, respectively, as shown in FIG. 5. The distance is measured longitudinally from the ns or fwp position toward the fs or rvp position parallel to the axis of the pipe. Therefore, if the transmitter is located at 12 O'clock and the receiver is located at the 6 O'clock at a distance l, the path of the first arrival of the electromagnetic waves would be helicoidal. The turns of the helicoidal path depends on the made of the electromagnetic wave propagation.

The helicoidal paths of the right-hand-screw and of the left-hand-screw about the pipe of a radius rᵤ can mathematically expressed as follows (FIG. 5).

Suppose a helix lies on a circular cylinder of radius r about the z axis, then:

r²=x²+y^{2.}

Suppose the distance of the successive windings at the helix is l as shown in FIGS. 5A and 5B.

We choose N(r,0,0), which the helix path passes through, on the x axis, and its projection on the helix path parallel to the z axis will be N′(r,0,l).

Suppose A(x,y,z) is a moving point which follows the helix path, and its projection on the x-y plane will be A′(x,y,0). Let 0A′ be the line directed from 0 to A′. We take as positive the sense of rotation and consider that angle from the x axis to 0A′ whose measure θ is zero when A is at N and rotates continuously as A recedes from N so that A(rcosθ, rsinθ, z).

By the nature of the electromagnetic wave propagation, the helicoidal path would obey the Fermat's principle. Therefore, this helicoidal path would take a minimum time for the wave to travel from point N to N′ on the three dimensional surface of the circular cylinder. The ratio of the velocity of the wave traveling in the direction of the helicoidal path to the velocity rotation of the cylinder about the z axis is constant.

Now, we must express z in terms of the change of θ. The angle that the helicoidal path makes with respect to the longitudinal line parallel to the z axis is φ, and its complimentary angle ψ=90°−φ with respect to the x-y plane must remain constant. Therefore, the projection of the velocity of the rotation of the helicoidal path onto the velocity of the rotation of the circular cylinder about its x axis must be constant such that

\overline{NN}′ cos ψ=\overline{NA}′+\overline{A′N}

If we let \overline{NA}′+\overline{A′N}=s, it follows that \overline{NN}′=(z²+s²)^{½.}

When θ rotates from 0 to 2π, the helicoidal path rotates from N to N′. As z increases at a constant rate, it maintains a constant intersection angle φ and ψ:z=kθ, when θ=0, z=0 and θ=2π so that z=s tan ψ.

Hence k=s tan ψ/2π Therefore, the parametric equations of the cylindrical helicoidal are

x=r cos θ,

y=r sin θ,

z=sθtan ψ/2π (or z=θcot θ/2π) (13)

Therefore, at any point A on the helicoidal path the vector form is

$$\hat{r} = {r}_{0} cos θ \hat{i} + {r}_{0} sin θ \hat{j} + s θ tan \frac{ψ}{2 π} \hat{k} or \\ \hat{r} = {r}_{0} cos θ \hat{i} + {r}_{0} sin θ \hat{j} + s θ cot \frac{φ}{2 π} \hat{k} . \qquad ( 14 )$$

Now let the distance between the ns or fwp position and the fs or rvp position be ml and let the circumferential distance of the circular cylinder be r₀θ. Then, Equations (14) become

$$\hat{r} = {r}_{0} cos θ \hat{i} + {r}_{0} sin θ \hat{j} + n θ \frac{m l}{2 π} \hat{k} \qquad ( 15 )$$

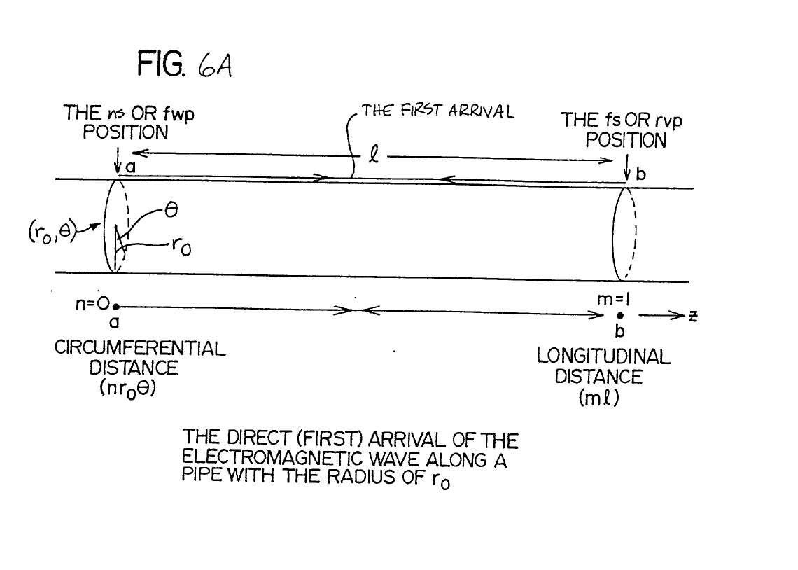

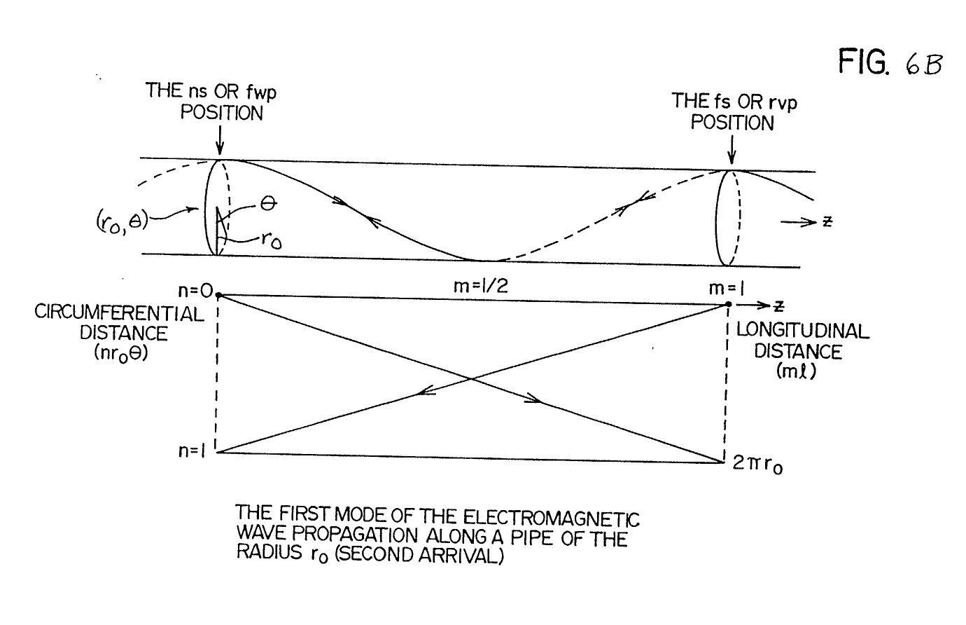

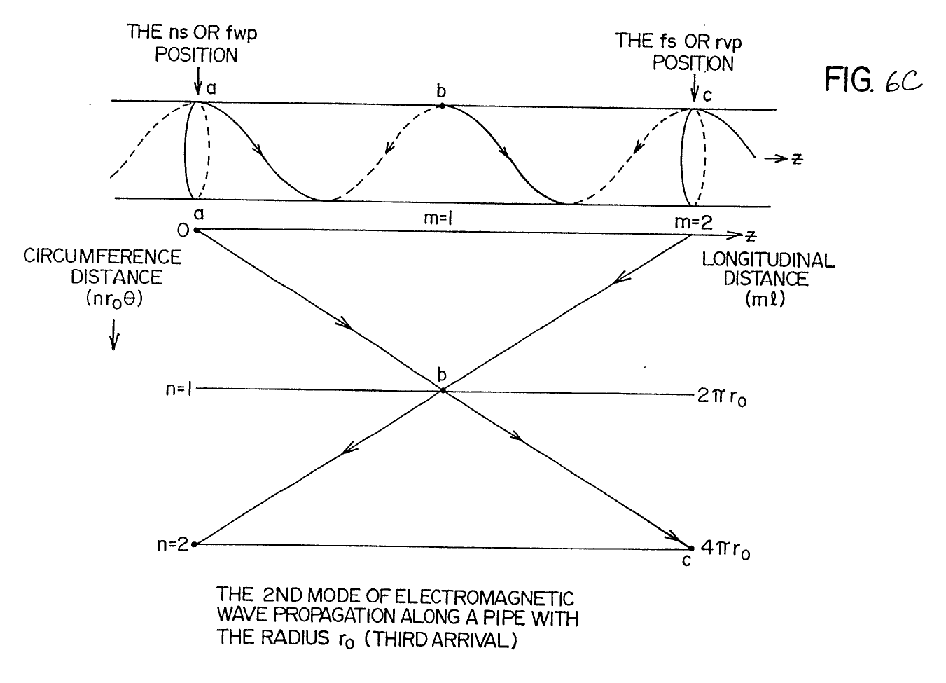

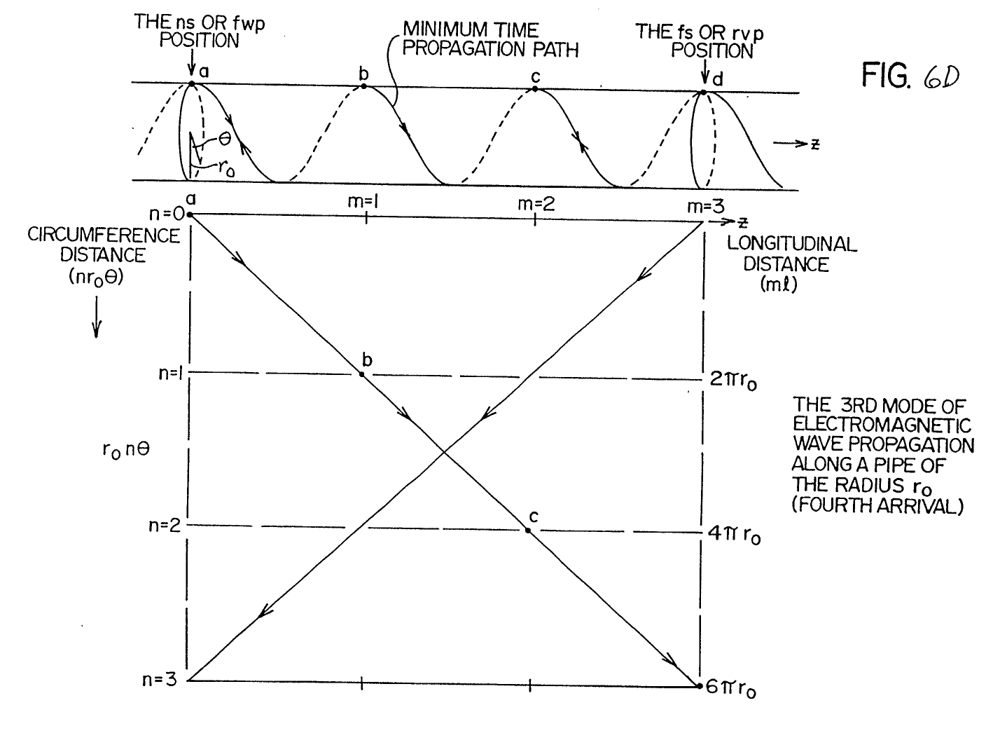

Now, we are able to describe the helicoidal paths for the first and subsequent arrivals as shown in FIGS. 6A, B, C, and D which illustrates not only the helicoidal paths in three dimensions but also the helicoidal paths mapped into the z-s plane in two dimensions. As expected, in two dimensions, the helicoidal paths degenerate into straight lines to represent the shortest path the electromagnetic waves travel that would take a minimum time.

From FIGS. 6A, B, C, and D it is clear that if an isolate corrosion is located at the 12 O'clock position in the middle between the as or fwp position and the Fs or rvp portion, only the odd arrivals of the electromagnetic waves would sense the corrosion, when the transmitter and the receiver are located at the 12 o'clock position. On the other hand, if this isolated corrosion is located at the 6 o'clock position and the transmitter and the receiver remain at the 12 O'clock position, then only the even arrivals of the electromagnetic waves would sense the corrosion.

Of course, there are a number of variables which must be considered, such as optimal positioning off the transmitter and receiver, the pulse width of the source, the location and extent of the corrosion, etc. All these variables would play critical roles in the CUI detection. Furthermore, for illustration purposes, the propagation path or the electromagnetic waves are represented by a single ray. In actuality, as stated before, because of the aperture of the transmitting and the receiving antennas, the propagation path of the electromagnetic waves has multi-rays, whose width are comparable to the aperture of the antennas.

10. Relevant Invention Devices Developed for the Present Invention

A. High-pass Antenna Design

Accompanying the present invention, passive source and receiving antenna have been developed and invented.

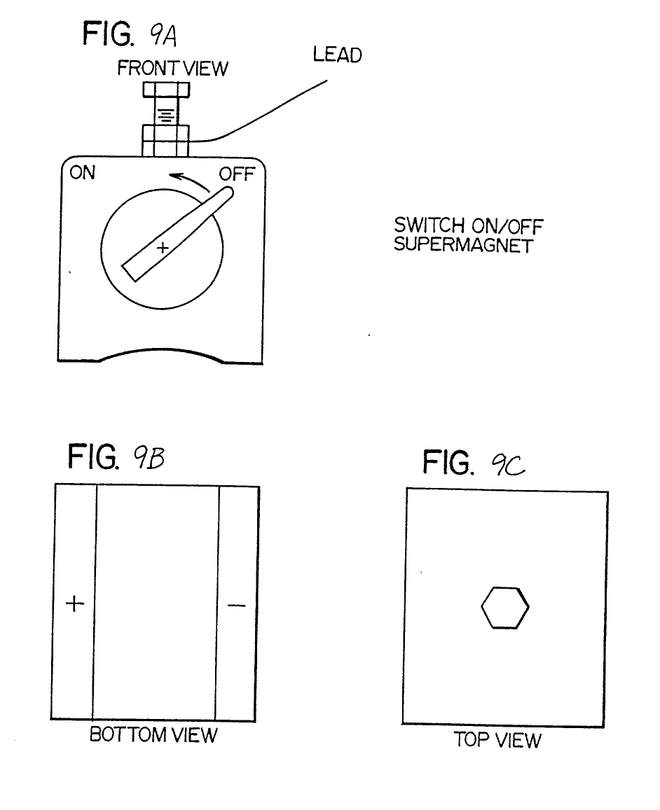

Excitation of a pipe or pipeline by an effective source transmitter and signals received by an effective receiver are achieved by means of the invented directional antennas in the present patent application. An alternative source and receiver is the supermagnet as shown in FIGS. 9A, 9B, and 9C.

B. Active Source Antenna

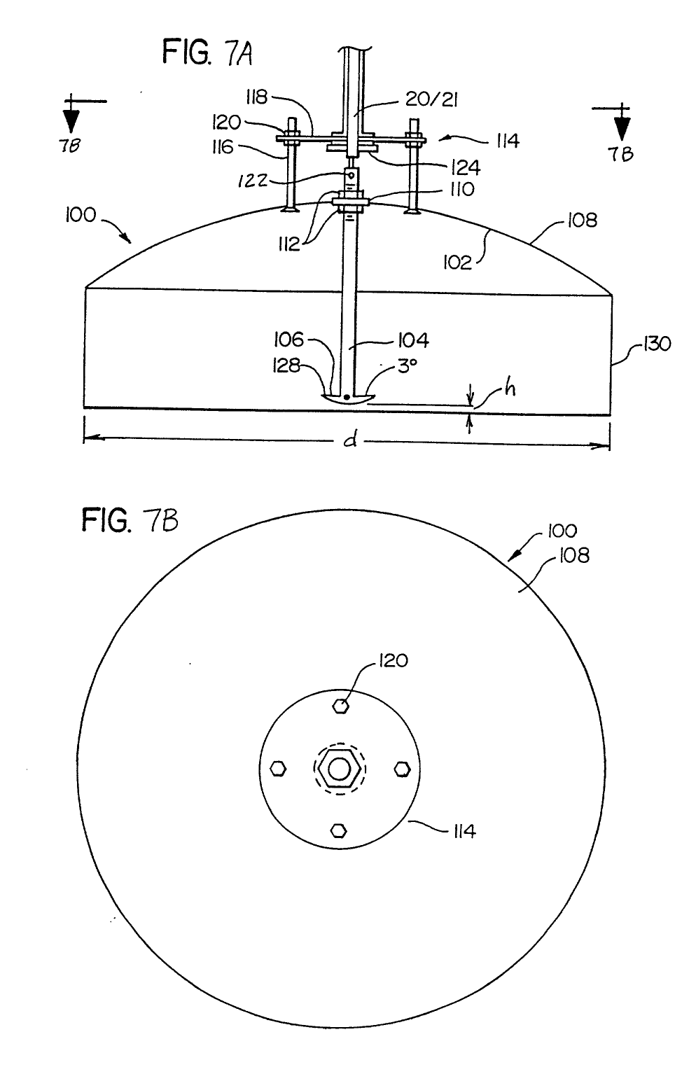

FIGS. 7A and 7B an show the detailed drawing of the directional antenna 100, which comprises a parabolic reflector 102 which is made of coated plastic, metal, or metallic dish, and has a width of aperture d. A prescribed optimal electric pulse from a pulse generator (See the choice of pulse width) travels through the source cable(s) 20, 21 to be an electromagnetic pulse (or waves), which impinges upon the brass focus rod 10, which extends downwardly along the center axis of the parabolic dish to the focus member 106.

The electromagnetic waves in turn are diffracted and radiated from the focus rod 104, and diffracted by the focus member 106 at the focus termination into the parabolic reflector. The electromagnetic waves from the focus rod 104 and focus member 106 are reflected from the concave side of the parabolic reflector 102 to excite the pipe A.

In order to minimize the undesired radiation from the surrounding pipes and conducting objects in a real field environment, in addition a radiation elimination parabolic shield 108 of the same curvature as the parabolic reflector is mounted on the top of the parabolic reflector 102. In the center of the parabolic reflector 102, there is a circular insulating disk 110, to which the threaded focus rod is fastened by two nuts 112 on the back (convex side) of the parabolic reflector.

A four posted standoff generally designated 114 and comprising four non-conducting vertical posts 116 arranged in a square pattern, and also a mounting plate 118, are mounted on the back (convex side) of the parabolic reflector 102 by nuts 120 threaded onto the upper ends of the posts 116. Through this standoff 114 the connections between the radiation-shield cable 20/21, which carries the electromagnetic pulse from the initial electric pulse generated by a pulse generator, are propagated through the source cable 20/21 to the focus rod 104. The single conducting wire of the radiation-shield coaxial cable is directly set into the focus rod and securely fastened by three set-screws 122 and a stabilizer 124 is mounted to the under-face of the mounting plate 118 of the four-posted standoff 114 to prevent the mobility of the cable lead. There is a lower circumferential plexiglass skirt 130 which is attached to the lower edge of the reflector 102 and extends downwardly therefrom. The distance between the termination of the focus member 106 and the lower rim of the skirt 130 is h.

On the basis of the reciprocity theorem, a passive receiving antenna is herein also used as a source transmitting antenna.

It will be noted that the upper surface 128 of the focal member 106 slants downwardly and radially inwardly toward the lower end of the rod 104 (toe-in about 3°-5°) to provide an optional focus function. Thus there are definite equal reflective paths between the various locations on the surface of the parabolic reflector 102 to the surface 128 of the focal member 106 to the length of the brass rod 104.

C. Passive Receiver Antenna

An antenna receiver in the invention is of passive type. The detailed design of a passive parabolic reflector antenna is the same as an active source antenna, except the antenna is not excited by the pulse generator but receives the electromagnetic waves as they are propagated along the pipe or pipeline and refracted as lateral waves and radiated through the insulation and the metallic shield off the pipe or pipeline. A simple electromagnetic ray path diagram illustrates the function of a passive receiver antenna. As the electromagnetic pulse is propagated along the pipe and refracted through the insulator and the metallic shield of the pipe, whether in the refineries or chemical plants, or in the actual trans-continental or interstate pipelines, the receive antenna thus receives the electromagnetic pulse from the pipe originated from the pulse generated and transmitted through the cable. These signals are attenuative, absorptive, and dispersive and subjected to radiation energy loss of the cable and the pipe or pipeline.

As shown in FIG. 6D, the rays of the electromagnetic waves which impinge upon the passive receiver antenna are reflected on the surface of the concave-side of the parabolic reflector 102 of the antenna and in turn focused at the focal member 106 of the antenna. As the result, the electromagnetic waves or signals are transmitted through the rod 104 and received by the receiving cable. In essence, the function of the passive receiver antenna, which receives the electromagnetic waves via the receiver cable is exactly opposite to that of the active transmitting antenna, which transmits the electromagnetic waves vis the source cable.

D. Circumference Distributed Source and Receiving Antennas

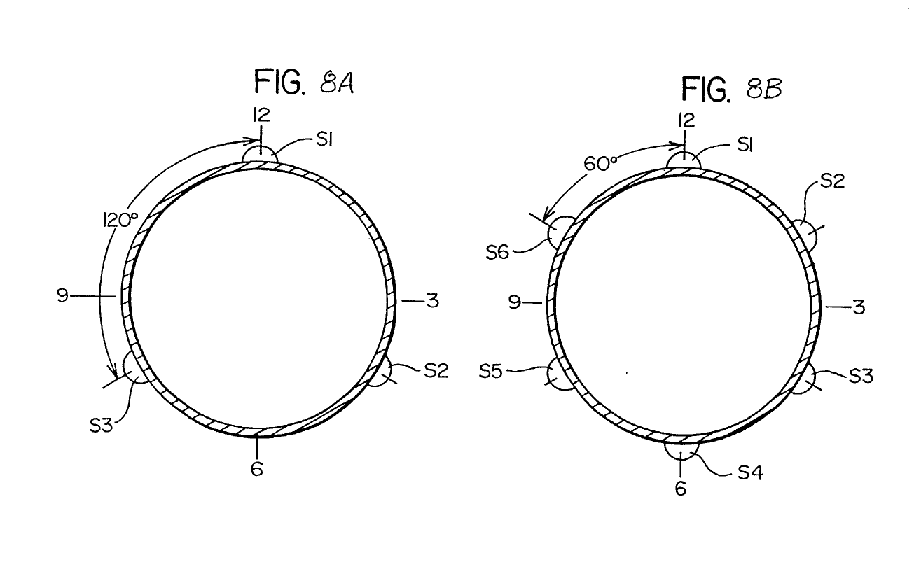

For a large-diameter pipe, corrosion of the pipe or pipeline is generally not distributed about the circumference throughout a circumference-distributed transmitting antenna of Type A (see FIG. 8A) using three antennas distributed at 120 degrees apart, and of Type B (see FIG. 8B) using six antennas distributed at 60 degrees apart about the circumference in the form of a ring are shown in the diagram. Sources S1, S2, and S3 for Type A and sources S1, S2, . . . S6 of Type B as designated can be excited simultaneously or one at a time as desired by means of a pulse generator through the source cable and controlled by a multi-connecting switch and controlled by a computer.

Likewise, circumference-distributed receiving antennas assume the same geometrical configuration as the circumference-distributed transmitting antennas. Signals from the individual receiving antenna of the circumference-distributed antennas can be received by any elemental antenna individually, all the elemental antennas simultaneously, or any combination of the elemental antennas controlled by a multi-connecting switch and a computer.

11. Choice of Optimal Pulse-Width

The choice of an optimal pulse width is of importance in detection of corrosion in a pipe or pipeline. For detection of corrosion, a fast-rise and narrow pulse width (one nanosecond or less), or a wide-open square wave with a pulse width greater than 1 (s (one microsecond) or even 1 ms (one millisecond), is preferred, depending on the separation of the transmitter and receivers. A wide-open square wave simulates Heaviside step functions, while a very narrow pulse approximately simulates a delta function. However, for a wide open pulse, the two responses from a positive Heaviside and a negative Heaviside step functions must not be overlapped and interfered in data acquisition.

A. Wide-open Square Wave

A pulse width of 1 μs or 1 ms square wave provides a positive Heaviside step or a negative Heaviside step function. The response of the cable to a Heaviside step function is essentially an RC-type decay the arrival of which is very difficult to be accurately determined. When the step function impinges on a pipe, the pipe excites high frequency components, which are comparatively more attenuative and dispersive than the step function pulse which is propagated in the co-axial cable.

The response of the cable(s) to the electric pulse excitation must be removed from the total response in order to analyze the response of the pipe to the propagation of electromagnetic waves. One of the convenient methods for removing the response of the cable(s) from the response of the cable(s) and the pipe or pipeline is by means of a high-pass receiving antenna, which is to be co-patented in the present invention.

B. Narrow Pulse-width Pulse

For detailed detection of corrosion, it is desirable that the pulse width be made as narrow as possible with its minimum of 1-2 ns and preferably in the picasecond ranges so that the first arrival and the subsequent arrivals would be separable.

With the present state-of-the-art, the stability of a pulse generator to generating such an extremely narrow pulse of much less than 1 ns is a challenge. Nevertheless, a pulse of 1 ns (i.e. one nanosecond) is quite attainable that would have a wavelength of about 1 foot in the pipe. The resolution of detecting corrosion with a Ins pulse in the neighborhood of 1-2 feet. An extremely narrow pulse, if its center-frequency is in the neighborhood of 10 GHz with a pulse width of 100 ps would be ideal. It then would have a wavelength of about 1 inch in a steel pipe or pipeline.

C. Sweeping Excitation Function

For determination of the precise arrival time of the electromagnetic waves, in addition to a wide open square wave and the fast-rise very narrow pulse, of excitation source chirping sweep frequencies can also be used.

Since the electromagnetic waves propagated along the pipe or pipeline are dispersed, a high-to-low sweeping and a low-to-high sweep excitation source in the frequency of a Ghz range can be used. The data processing of the sweeping frequency source functions thus can be implemented by moving window cross correlation technique.

12. Positioning Transmitter and Receiver

Detection of corrosion in a pipe or pipeline in question particularly of large diameters must optimally position the transmitter and receiver for either the single-pulse or the dual-pulse techniques using a single cable or multi-channel cable. Proper positioning the transmitter and receivers thus allows the wave propagation paths to cover certain cross section(s) in circumference-wise and certain portion of the pipe or pipeline in length-wise.

In the cross section along the circumference, the transmitter and the receiver can be aligned in the same azimuthal angle or the longitudinal direction. Likewise, the transmitter can be positioned at the 12 o'clock position, and the receiver can be positioned at any o'clock position, say 3, 6, 8, 9 . . . 11 o'clock position. Vice versa, while the receiver is positioned at one particular position, the transmitter is positioned at various positions along the circumference of the pipe or pipeline. Although there are many exceptions, corrosion generally occurs near the bottom of a horizontal pipe or pipeline, i.e., about the 6 O'clock position, where the moisture condensates and water accumulate most.

The above method of positioning the transmitter and the receiver thus leads to the development of the circumference-distributed transmitter and the circumference-distributed receiver by means of a relay switch to be preprogrammed and controlled by a computer to transmit the electromagnetic pulse from a transmitter at a designated position to be received at any azimuthal angle as desired or any other combination of positioning the transmitter(s) and the receiver(s).

13. Corrosion Under Insulation (CUI)

A. Corrosion in a Relatively Small Diameter Pipe

With the foregoing in mind, let us now turn our attention back to FIG. 1A and assume that there is a corroded section E on the steel pipe or pipeline A and that this extends from a location from the contact point 36-4 beyond the contact point at 36-5 and part way to the contact point 36-6. Let us further assume that the remainder of the pipe A on both sides of this corrosion area E have no corrosion so that the segment of the pipe or pipeline A at these other sections would be uniform.

Let us assume that the test procedure has been utilized as described above, namely that it begins by transmitting pulses from the cable end 22 and into transmitting contact point 44, where the transmitter is located and that these pulses are received by the various channels in sequence or multiplexed, first at the receiving location 36-1, received at the receiving location 36-2, all the way to the last receiving location 36-N.

As described previously herein, with all of the time interval characteristics of all the components of the System having been already predetermined, it is possible to ascertain the first arrival and subsequent arrival travel time during which a pulse travels, for example, from the transmitting contact point 44, which is also the first receiving contact point 36-1, to the receiving contact point 36-2, etc. Thus, (also as described previously herein), it is possible to determine the time interval between which a pulse would travel between any two points, provided that dispersion is taken into consideration, i.e. between the point 44 and any one of the points 36-1 through 36-n, also in reverse from the transmitting contact point 51 to any one of the receiving contact points 36-n through 36-1.

Thus, when the pipe or pipeline A, as shown in FIGS. 1A and 1B, is being tested, and the data are analyzed so that the distance between the source transmitting point 44 and each of the receiving contact points plotted along a horizontal axis, and the travel time for the source transmitting point to each of the receiving contact points is plotted along the vertical axis, for those portions of the pipe under test which have not been subject to corrosion, the related portions of the curve would have a constant slope to indicate a given velocity which is characteristic of the uncorroded sections of the pipe A. However, the portions of the curve relating to the sections of the pipe which have been corroded would have a steeper slope, thus indicating a reduction of velocity at these locations.

Also, as indicated previously, since the time interval for a pulse to travel between any of these two points 36 can be determined and the distance between these contact points 36 on the pipe A has already been measured, it is possible to measure the velocity of the wave propagated between any two pair of contact points 36. The data thus yield the differences of the travel time between any pair of two contact points 36, so that the effect of dispersion is minimized, provided that the distance between the two adjacent receiving contacts is small, i.e., about less than 10 feet under normal conditions.

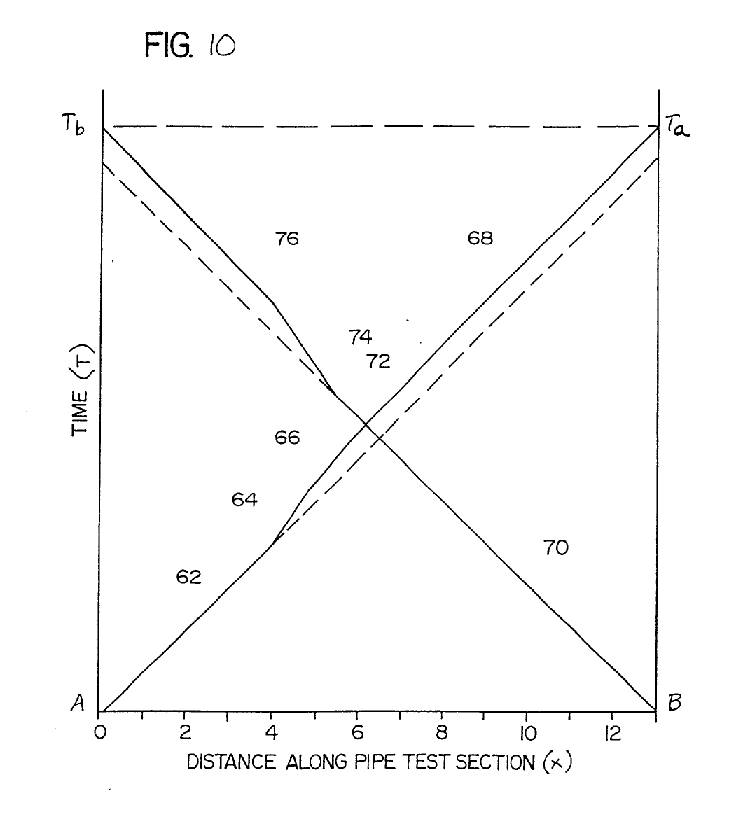

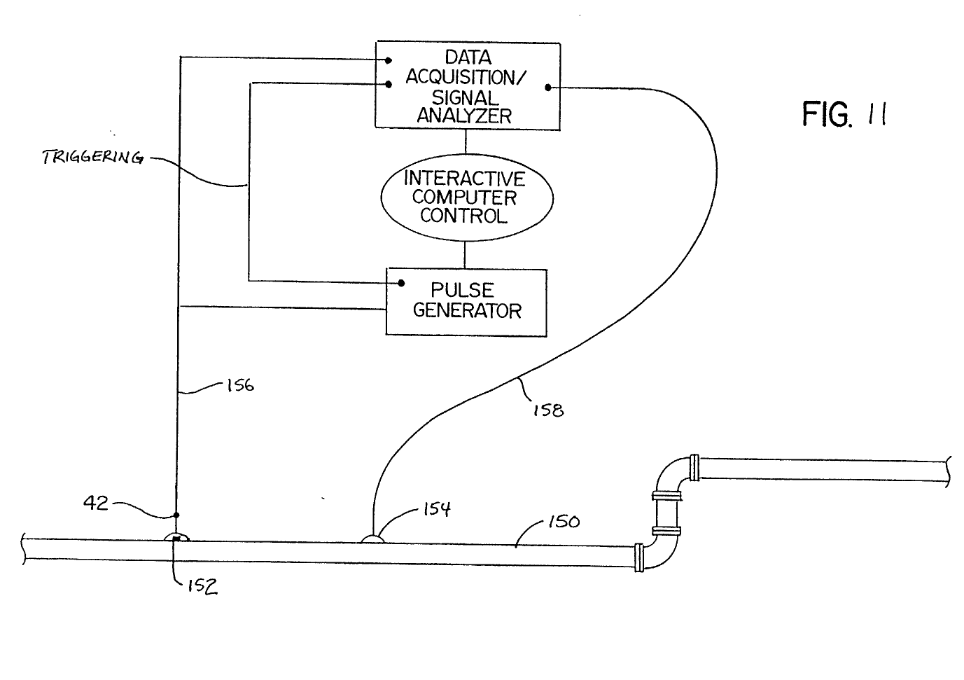

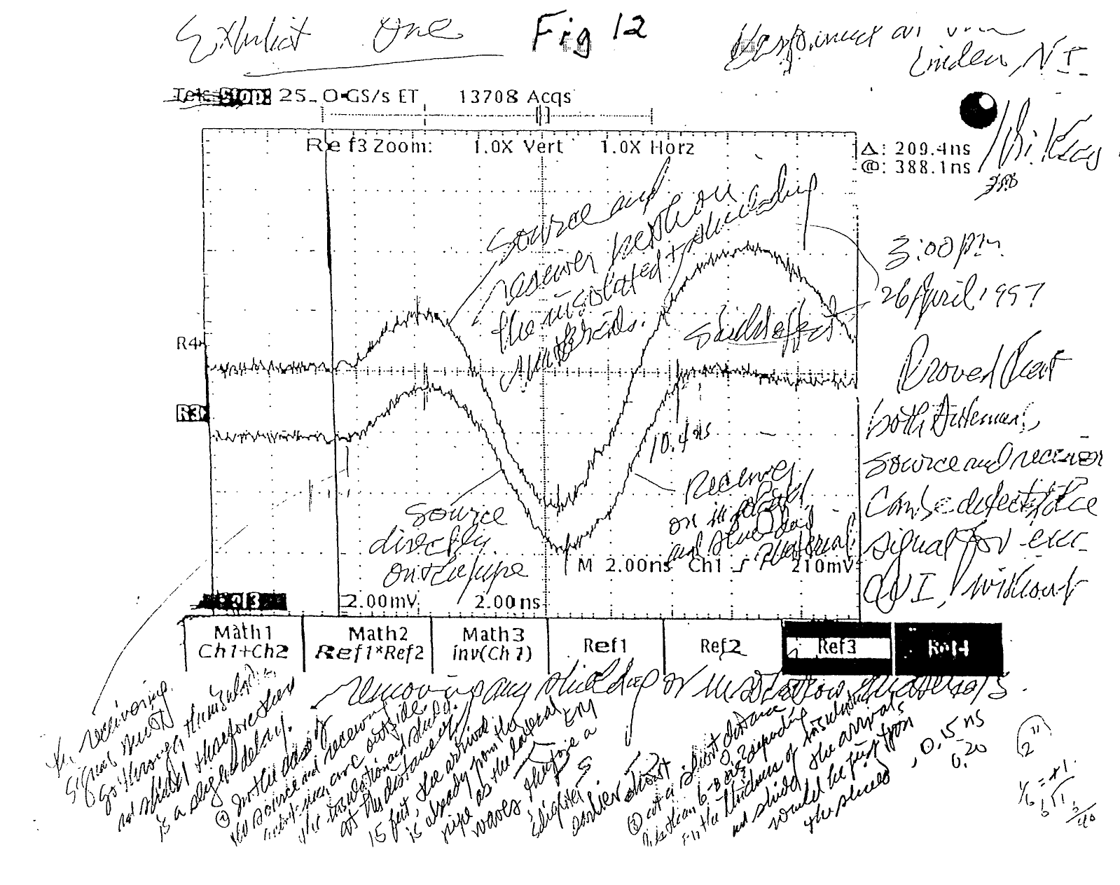

Reference is now made to FIG. 10 which is a simplified graph which shows how the curves might appear when the pipe section shown in FIGS. 1A and 1B is being tested, and with the corrosion area E being positioned as shown in FIGS. 1A and 1B.

It is apparent from the discussion presented above that where the corrosion zone E extends the full length form the contact point at 36-4 and 36-5 the electromagnetic properties including conductivity, permittivity, and permeability change, and that, in turn, the velocity of the pulse traveling between point 36-4 and 36-5 would become reduced. The part of the pipe section between the contact points 36-5 and 36-6 is also in the corrosion area E, and (depending upon various factors) it is expected that the pulse in traveling along the pipe section from the contact point 36-5 to 36-6 would have the phase velocity slower than in the section of good pipe.

To relate this to the graph shown in FIG. 7, the curve portion at 62 represents the time and distance values of the pulses traveling through the pipe test section from the contact locations 36-1 through 36-4. Since the pipe section between the points 36-1 and 36-4 is not corroded the slope at 62 would be uniform. At the pipe section between points 36-4 to 36-5 of the corroded pipe the corresponding portion 64 curve is at a steeper slope, indicating that the velocity is decreased, i.e. a travel time delay in the distance 36-4 to 36-5. Then the pulse in traveling from the contact location 36-5 and 36-6, which is in part of the corroded pipe, would experience a velocity increase more than the pulse traveling through the pipe section from 36-4, 36-5. From the contact location 36-5 on to the end of the test section at 36-n, the curve portion 66 to 68 would have substantially the same slope as the curve at 62, since the pipe section from 36-6 to 36-n is non-corroded, and thus again has a uniform section.

Then when the second part of the analytical testing process is done, the curve starts at the contact location 36-n and continues upwardly toward the left. Since the pipe section from contact point 36-n to 36-6 is uniform and not corroded, the curve portion corresponding to this pipe section has substantially the same slope as the curve portions at 62 and 68. At the curve portions indicated at 72 and 74, it will be observed that the slope of these 70 two portions are, respectively, the same as the curve portions 66 and 64. Then, the curve portion 76 corresponding to the path of travel from the contact point 36-4 to 36-1 has the same slope as the curve portion at 70. One of the important points is that by virtue of reciprocity the amount of travel time from A to B and from B to A, in principle, must be the same, (i.e., Ta=Tb) at least for the first arrivals. However, under an asymmetrical case of corrosion configuration that principle of reciprocity may not hold, i.e., the traveling paths for a given mode for the ns or fwp and fs or rvp profiling, may be slightly different.

By testing the pipe section in both directions, verification is Given to the location of corrosion. Beyond this, however, there may be additional benefits in measuring the propagation of the pulses in both directions. For example, it is possible that depending upon the particular pattern of corrosion, for late arrivals there could be differences in the manner of wave propagation.

B. An Isolated Corrosion on a Large-Diameter Pipe

Detection of a small isolated corrosion in a large-diameter pipe requires further consideration. In principle if the isolated corrosion is located in the propagation path of the electromagnetic waves, these waves would pass through the isolated corroded portion of the pipe. Nevertheless, the electromagnetic waves always seek to take the shortest path which would take a minimum amount of time. If the electromagnetic waves would take a longer time to propagate across the spot of the isolated corrosion than the waves take a detoured diffracted path around the small corrosion, the waves would take the latter diffracted path, which is comparatively a shorter path with a least time.

Because the waves take a detoured diffracted path around the small isolated corrosion, it also results in a time delay, which is not directly related to the time delay for the waves passing through the corroded portion of the pipe, but it is indirectly related to the presence of the isolated corrosion. Although it will be difficult to differentiate the two different time delays, the actual time delay would still be an indicative of the presence of a small, isolated corrosion.

14. Attenuation, Dispersion, and Phase Shift

In addition to the changes in velocity of the pulse traveling through the corrosion area, it is surmised, based upon analysis and experimental results, that valuable information can be obtained from analyzing the waveforms themselves. Thus, the signal analyzer C would form what might be termed “electromagnetograms” for the waveforms (which the originators have abbreviated to “EM-GRAMS”), from which travel time, attenuation dispersion and phase shift ofthe electromagnetic waves are analyzed. This process of field measurements has (as indicated previously herein) been termed by the inventors as “True Electromagnetic Waves” (abbreviated to “‘TEMW’”).

The result of the forward-and reverse profiling would include TT-X (travel time in nanoseconds versus distance in feet, the slope of which gives slowness and its inverse, velocity), V-X (voltage versus distance, the graph of which yields attenuation of the electromagnetic wave propagation), v-ω (group velocity versus frequency at each receiving contact point with the pipe or pipeline that would give the dispersion characteristics), and the φ-ω (phase shift versus frequency, which gives the phase shift).

The signal analyzer C could be, for example, a DSA 601 or 744 signal analyzer made by Tektronics. Also, as further analysis is done, this signal analyzer could be a combination of instruments, including a spectrum analyzer similar to a family of analyzers. This could measure time, attenuation, dispersion, phase shift, and frequency content through special processing software on computers.

The pulse generator B could be a pulse generator similar to the Stanford Research System Pulse generator DG 535A, this having a 200 picasecond jitter. The interactive computer D could be a high speed PC personal computer laptop work stations, such as currently available Pentium-chip computers. This computer would control the various functions described herein, collect and store the data, and with an additional computer perform demultiplexing, stacking, display, and data processing and interactive interpretation.

Tests incorporating the system, of the present invention have been performed on carbon steel pipes of four inch diameter and also twenty-four inch diameter. The width of the pulses imposed on the pipe have been as great as one millisecond, and could also be less than one nanosecond. The pulses used have been square waves. The voltage of the pulses could vary, and these could be as high as four volts or higher, or as low as possibly one hundred millivolts or lower, either plus or minus voltage, with a current of a few milliamps so that the power is less than one watt.

It is to be recognized that various modifications could be made in the present invention without departing from the basic teachings of this application.

15. Embodiment Seven: Transmitter Arranged Outside Insulation and Shield

The Seventh Embodiment of the present invention is illustrated schematically in FIG. 11. This seventh embodiment is applicable to all of the other six embodiments to be used as the source and the receiver shown herein, and is particularly well adapted to conduct the testing in a situation where the transmitter and receiver are required to be moved to various optimal locations.

In FIG. 11, there is shown the pipe 150 which is insulated and has a metallic shield surrounding the insulation. In the earlier Embodiment First to Embodiment Sixth, while the receiving antenna was placed directly against the shield that surrounds the insulation, the transmitter of either of supermagnets or of antenna was placed directly against the pipe, this being accomplished either by placing it against bare pipe or if there was a layer of insulation cutting away a section of the insulation and surrounding shield so that the transmitter could be placed directly onto the bare pipe.

It has now been found that equally satisfactory and efficient results can be obtained by placing the transmitter as well outside of the insulation and the shield. This invention is of a breakthrough due to the fact that the insulation and the shield around the pipe and under test is no longer required to be removed. That means the tests can be performed under in situ conditions.

With reference to FIG. 11, substantially the same apparatus is shown, as in the previous embodiments of one through six, with a data acquisition/signal analyzer (D/S) C, interactive computer control D and a pulse generator B. There are two antennas 152 and 154 or one supermagnet 152 and antenna 154 connected by respective cables 156 and 158 to both the pulse generator and the data acquisition signal analyzer, as the source and receiver, respectively. The source and receiver 152 and 154 are arranged, along with the associated apparatus.

This apparatus was used in actual field testing where the pipe under test was as small as two inches, and as large as eight inches, and with the insulation layer having a thickness of one inch or two inches and covered by a metallic shield.

For comparison, the arrangement of the present invention was tested on pipe with both the transmitter and receiver being adjacent to the pipe but outside the insulation and the shield, and direct comparisons were made with two other situations, one where the transmitter (antenna) was placed directly against the bare pipe, with the receiver (antenna) being placed adjacent to but outside of the insulation and the shield, and the other where both the transmitter (antenna) and the receiver (antenna) were placed against the pipe. The printouts are directly from TEKTRONIX 744A's CRT, with a vertical scale 2 mv and a horizontal scale 2 ns.

In FIG. 12, there is shown the test results where the transmitter (antenna) was first placed against the bare pipe, and the receiver (antenna) adjacent to the pipe, but outside of the insulating and shield. The receiver (antenna) was spaced from the transmitting antenna by a 15-foot distance along the pipe. The coverage of the insulation and shield of which is 15.5 feet. The resulting waveform that was received at the receiver (antenna) is shown at 220 in the lower part of the waveform of FIG. 12.

Then the same test was conducted, but in this instance both the transmitter and receiver were positioned outside of the insulation and the shield, but adjacent thereto. The resulting waveform is shown at 222 in the upper part waveform of FIG. 12. It can be seen that the two waveforms are virtually identical, following a similar pattern, but notably after 10.4 nanoseconds the waveforms of the upper part waveform of FIG. 12 indicate the effect of the insulation and the shield on the termination of electromagnetic wave propagation, which is being reflected.

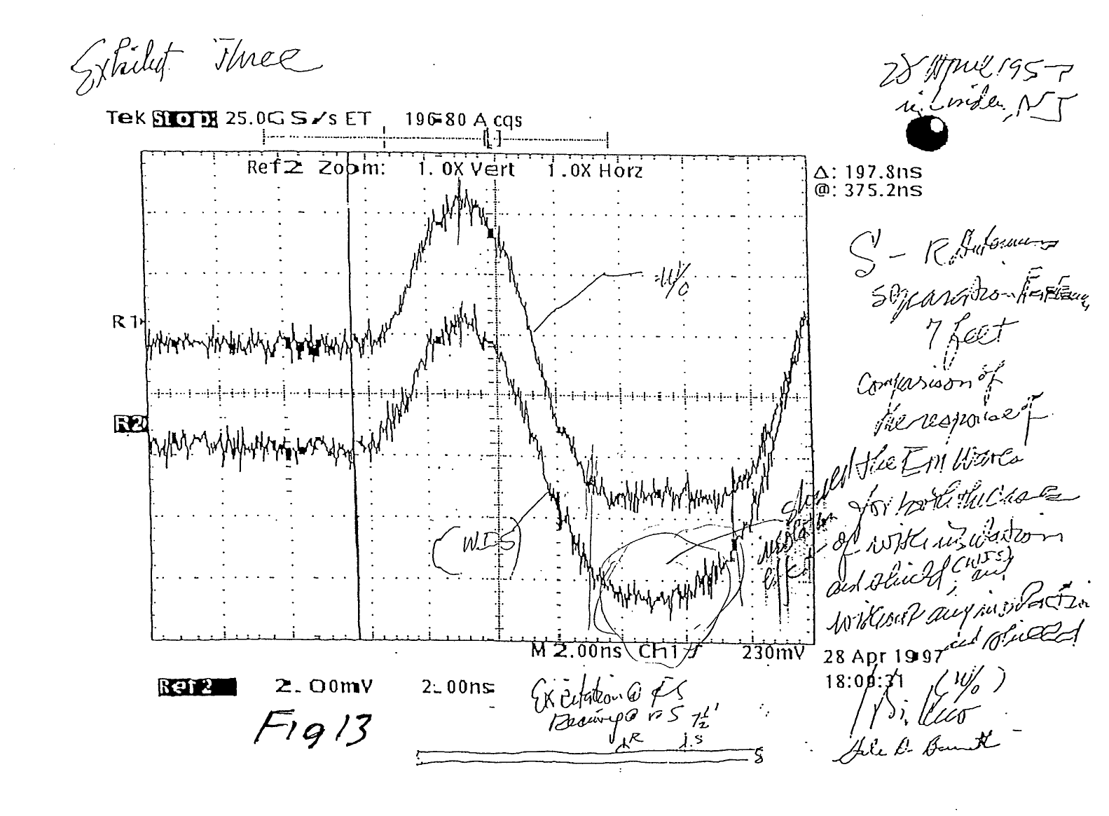

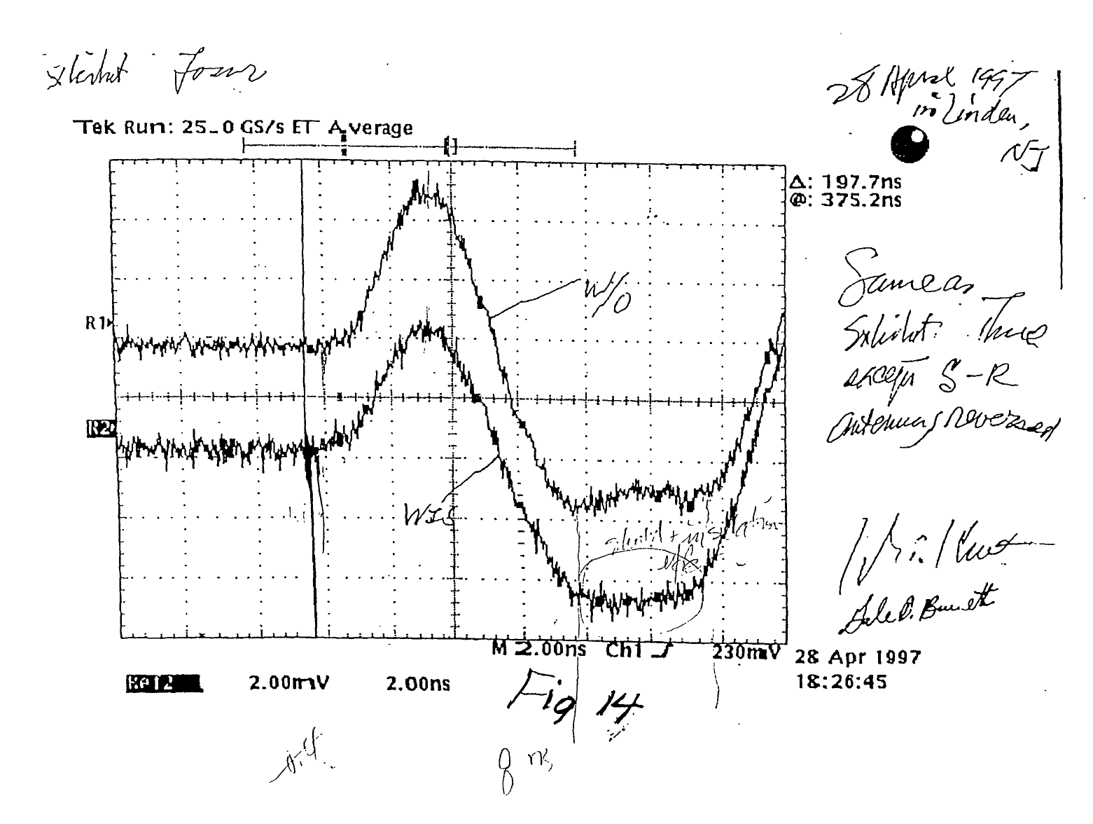

Then a second test was run where both the transmitter (antenna) and the receiver (antenna) were placed against bare pipe. The waveform which was received at the receiving antenna is shown at 224 in the upper waveform of FIG. 13. Then both the antennas were placed outside of the insulation and the shield, but adjacent thereto. The results are shown at 226 in the lower waveform of FIG. 13. Again, the initial portions of the two waveforms are virtually identical and the rest of the curves are dissimilar, but notably after about 7.4 nanoseconds indicate the effects of the termination of the insulation and the shield on the electromagnetic wave propagation. This test was conducted with the transmitter and receiver 7.5 feet apart with the insulation of shield of 7½ feet.

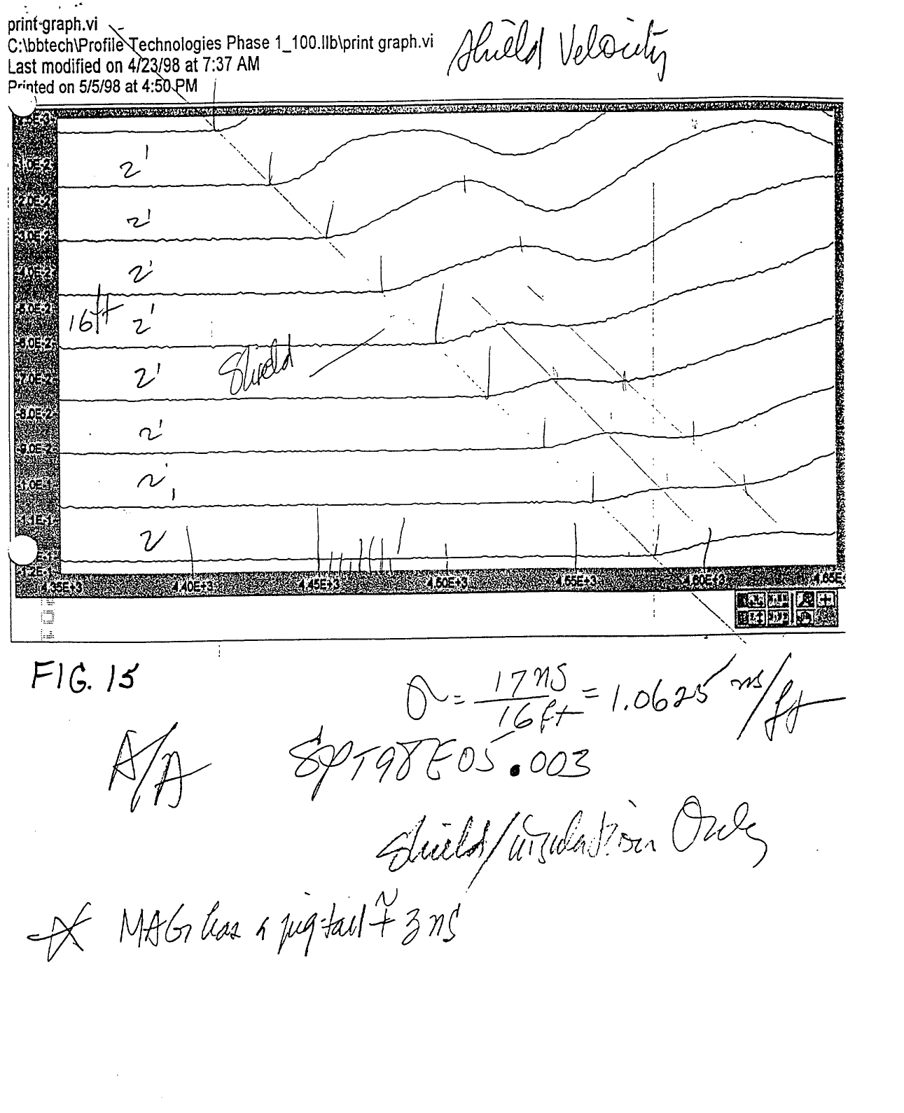

FIG. 14 shows substantially the same information as FIG. 13, except in this instance, there was reverse profiling. More specifically, the receiver (antenna) was then made the transmitter (antenna), while the transmitting antenna was made to be the receiving antenna. Again, it can be seen that the curves of FIG. 14 are similar to those shown in FIG. 13. That means at least in the present case the theory of reciprocity holds.

The implication of the above three tests is that there is no doubt that CUI can be tested outside or adjacent to the insulation and shield without striping off the insulation and shield.

In this testing, electrically single conductor cables were used, but fiber optic cables could also be used.

As indicated, this Embodiment Seven provides reliable test results, and yet provides substantial benefits in field testing. Several modes of operation could be employed, generally as described previously herein. For example, one method of profiling would be to move both the transmitter and receiver along the pipe for each operation. Thus, the transmitter would be at point “a” on the pipeline and initially the receiver also would be at point “a”. Then the receiver would be moved to point “b”, and a pulse transmitted made from point “a” to point “b”. Then the transmitter would be moved to point “b”, then the receiver is moved further to point “c” along the pipe, with a pulse again being transmitted. Then the transmitting antenna would be moved to point “c” and the receiver to point “d”, with this pattern being repeated, moving along the pipe.

The process would then be reversed (the transmitter sending a signal from point “d” to the receiving antenna at point “c”, etc. This is done simply by reversing the arrangement shown in FIG. 11.

Alternatively, the transmitter could remain at point “a”, while the receiver is moved to points “b”, “c”, “d”, etc. at various distances from the transmitter. And the procedure is reversed.

Also, it is to be understood that either or both of the antennas could be moved further away from the pipe under test, i.e., in free space by distances of as high as tens of feet, or even further, depending upon the strength and directionability of the pulse sent by the transmitter and also the capability and directionality of the receiver to receive the signal.

However, if there are secondary and additional sources of interference nearby, the distance of the antennas from the pipe under test would be limited. However, under favorable conditions these interferences can be taken into account in data analysis and interpretation. For example, if there are a number of pipes which are closely adjacent to one another (e.g., when they are parallel in a pipe rack), there would be substantial interference. When the pulse is directed to the pipe under test, this in turn would cause the pipe to be excited, which would in turn radiate electromagnetic energy to the adjacent pipe to excite the adjacent pipe and mutually interfered. Then the adjacent pipe, having been excited, would in turn transmit electromagnetic waves back to the first pipe under test. This could be a significant cause of interference. In actual practice, the sources of interference would be noted in the logbook for the test data, for taking into account in the analysis of the waveforms developed during testing.

It is apparent that various modifications could be made to the present invention without departing from the basis teachings thereof

16. Further Experimental Test Results of the Pipe Under Insulation and Shields

The following are the further experimental test results for a variety of cases of the pipe under insulation and shield.

Insulations were made of foam with a thickness of 1.5 inches and the shield was made of galvanized steel with a thickness of one-sixteenth of an inch. In all the tests, the supermagnet was used as the source as described in FIGS. 9A, B, and C of U.S. patent application Ser. No. 08/807,645 which was directly attached to the galvanized steel shield. The inner diameter of the pipe (plastic and carbon steel) was 4 inches with a thickness of ⅜ inch. The receiver was an 10-inch inverted parabolic reflector antenna as described in FIGS. 7A and B of 08/807,645. The outmost layer of the shield and the foam insulation layer were tightly coupled and concentrically placed with respect to the surface of the pipe. For all the cases, the source was fixed and the receiver was moving at an increment of the distance of 2 feet. The supermagnet source was placed at the position of 12 o'clock position and all the data were taken with the receiver at the position of 12 o'clock. It has been tested and proven that the source can be either supermagnet or antennas as well.

A. Case One: Insulation and Shield Alone

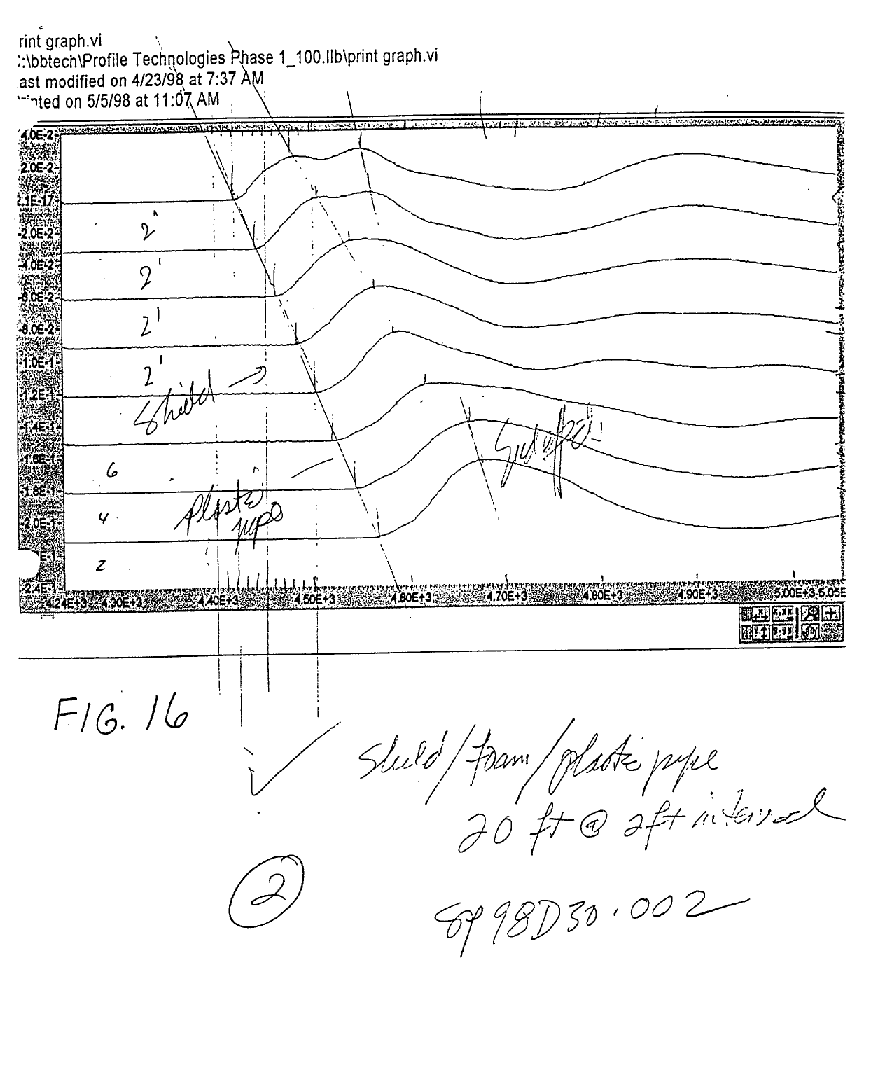

This case was to test the effect of the insulation and the shield alone on the electromagnetic waves. A total distance of the pipe segment was 16 feet in length. FIG. 15 is the original data of the EM-gram, showing the waveforms at each 2-foot incremental distance along the axis of the cylindrical configuration of the shield outside the insulation concentrically. The X-axis represents the time in nanosecond (ns) and the Y-axis represents the amplitude. As expected, the first arrival and the subsequent arrivals give a slope to represent the velocity of the shield only. The slope of the travel time vs distance is as expected to be constant, i.e., a straight line or a slowness of this particular galvanized steel shield 1.0625 ns/ft. This result is significant due to the fact that the electromagnetic waves are indeed propagated through the shield.

B. Case Two: Insulation and Shield Surrounding a 4-inch Plastic Pipe

This case was to test the nature of the effect of the shield, insulation and the plastic pipe on the electromagnetic waves. FIG. 16 gives the original data of the EM-gram, representing the waveforms as a function of the axial distance along the pipe. Note there is a constant slope at the distance from 0 to 6 feet, which is interpreted as the electromagnetic waves propagated through the shield. The arrivals thereafter are the lateral waves radiated from the interface of the plastic pipe and the air gap between the insulation and the plastic pipe assuming the electromagnetic waves propagated with the velocity in the air. The second arrivals on the bottom two traces are disturbed by the end effect of the finiteness of the pipe.

C. Case Three: Insulation and Shield Surrounding a 4-inch Carbon Steel Pipe

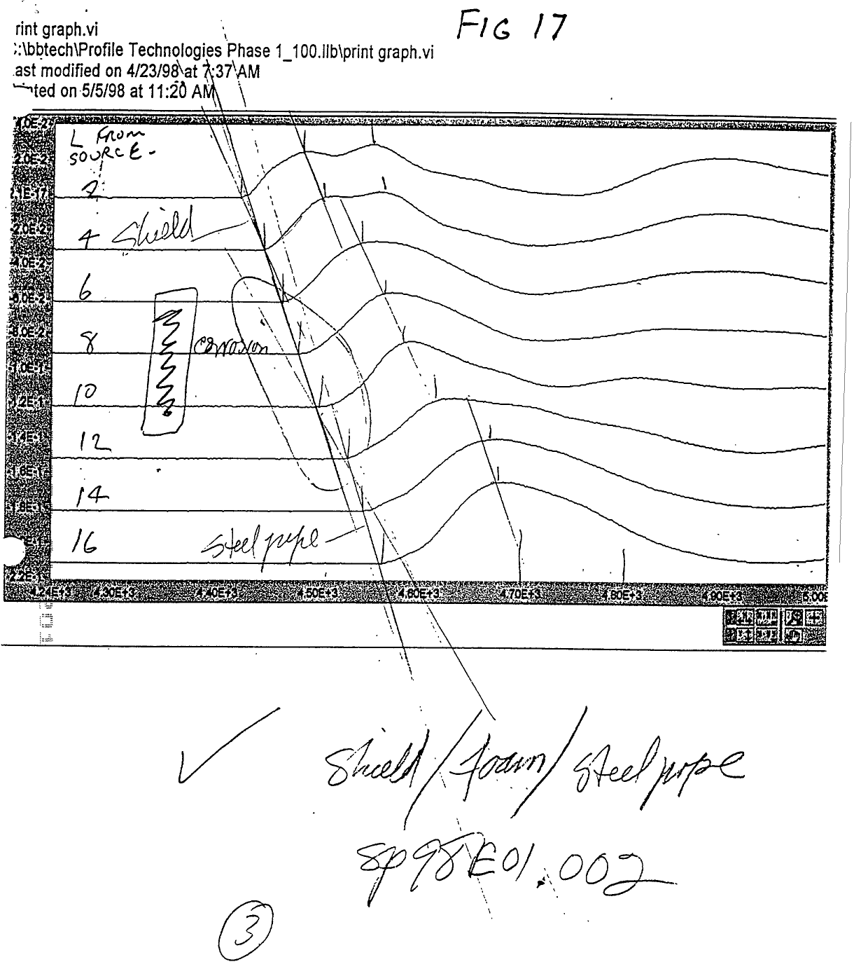

The geometrical configuration of this case was exactly the same as in Case Two above, except the plastic pipe was now replaced by a carbon steel pipe within which there was a corroded section of about 4 feet. FIG. 17 shows the original data of the waveforms versus the axial distance from the source. Note now there are three slopes; the first slope represents the electromagnetic wave propagated through the galvanized steel shield, the second slope represents the electromagnetic waves propagated through the corroded section and the the third slope represents the electromagnetic waves through the carbon steel pipe itself with a highest velocity or a slowest slowness among the three. The interference of the electromagnetic waves propagated through the shield, the corroded section and the carbon steel pipe prevent to give a clear cut of waveforms after the first arrivals.

We claim:

1. An antenna assembly for transmitting electromagnetic signals to and receiving electromagnetic signals from a conductive member, comprising:
a reflector member defining a reflecting surface having a substantially parabolic cross-section;
a focus rod;
a focus element having a first surface, where the focus element is mounted on the focus rod; and
an insulating member, where the insulating member mounts the focus rod on the reflector member such that the focus element is arranged substantially at the focal point of the reflecting surface with the first surface facing the reflecting surface; whereby
when the reflector member is arranged with the reflecting surface facing the conductive member,
electromagnetic signals travel along the focus rod, radiate from the focus element, and reflect off of the reflecting surface and are transmitted to the conductive member, and
electromagnetic signals travelling along the conductive member radiate from the conductive member, reflect off of the reflecting surface, excite the focus element, and travel through the focus rod.

2. An antenna assembly as recited in claim 1, in which the focus rod is operatively connected to at least one of an electromagnetic source and an electromagnetic receiver; wherein
electromagnetic signals generated by the electromagnetic source excite the conductive member, and
electromagnetic signals travel through the focus rod to the electromagnetic receiver.

3. An antenna assembly as recited in claim 1, in which the focus rod is operatively connected to an electromagnetic source such that electromagnetic signals generated by the electromagnetic source excite the conductive member.

4. An antenna assembly as recited in claim 1, in which the focus rod is operatively connected to an electromagnetic receiver, where electromagnetic signals travel through the focus rod to the electromagnetic receiver.

5. An antenna assembly as recited in claim 1, in which the focus rod is operatively connected to at least one of an electromagnetic source and an electromagnetic receiver through a cable, where a conductor of the cable is connected to the focus rod.

6. An antenna assembly as recited in claim 5, further comprising a stand-off assembly configured to fix a location of a cable lead of the cable relative to the focus rod.

7. An antenna assembly as recited in claim 5, further comprising at least one screw for fixing the conductor of the cable to the focus rod.

8. An antenna assembly as recited in claim 6, in which the stand-off assembly further comprises a mounting plate and a plurality of post members, where the post members extend between the mounting plate and the reflector member.

9. An antenna assembly as recited in claim 6, in which the stand-off assembly comprises a stabilizer for maintaining a position of the cable lead relative to the focus rod.

10. An antenna assembly as recited in claim 1, further comprising a shroud member mounted on the reflector member, where the shroud member extends a predetermined distance beyond the focus member.

11. An antenna assembly as recited in claim 1, in which the first surface of the focus member slants downwardly and radially inwardly away from the reflector surface.

12. An antenna assembly as recited in claim 11, in which the angle of the first surface of the focus member with respect to horizontal is substantially between three and five degrees.

13. An antenna assembly as recited in claim 1, further comprising a shield member arranged on top of the reflector member to minimize undesired radiation.

14. A method of transmitting electromagnetic signals to and receiving electromagnetic signals from a conductive member, comprising the steps of:
providing a reflector member defining a reflecting surface having a substantially parabolic cross-section;
mounting a focus element having a first surface on a focus rod; and
mounting the focus rod on the reflector member using an insulating member such that the focus element is arranged substantially at the focal point of the reflecting surface with the first surface facing the reflecting surface;
arranging the reflector member such that the reflecting surface faces the conductive member;
transmitting electromagnetic signals along the focus rod such that the electromagnetic signals radiate from the focus element and reflect off of the reflecting surface towards the conductive member; and
receiving electromagnetic signals that radiate from the conductive member, reflect off of the reflecting surface, excite the focus element, and travel through the focus rod.

15. A method as recited in claim 14, further comprising the steps of operatively connected the focus rod to at least one of an electromagnetic source and an electromagnetic receiver.

16. A method as recited in claim 14, further comprising the steps of fixing a location of a cable lead of the cable relative to the focus rod.

17. A method as recited in claim 14, further comprising the step of maintaining a position of the cable lead relative to the focus rod.

18. A method as recited in claim 14, further comprising the step of mounting a shroud member on the reflector member such that the shroud member extends a predetermined distance beyond the focus member.

19. A method as recited in claim 14, further comprising the step of forming the first surface of the focus member such that the first surface slants downwardly and radially inwardly away from the reflector surface.

20. A method as recited in claim 14, further comprising the step of arranging a shield member on top of the reflector member to minimize undesired radiation.
